(19) United States
(12) Patent Application Publication
(10) Pub. No.: US 2026/0359954 A1
(43) Pub. Date: Nov. 12, 2026

(54) HYBRID BAYER-LUMA HARDWARE-EFFICIENT MULTI-SCALE DETAIL RESTORATION AND ENHANCEMENT

(71) Applicant: Intel Products IP LLC, Santa Clara, CA (US)

(72) Inventors: Hava Matichin, Petah Tikva (IL); Anatoly Litvinov, Binyamina (IL); Dor Barber, Herzliya (IL)

(73) Assignee: Intel Products IP LLC, Santa Clara, CA (US)

(21) Appl. No.: 19/722,767

(22) Filed: Jun. 27, 2026

(51) Int. Cl. G06T 5/77; G06T 5/73; G06T 5/94

(52) U.S. Cl. CPC G06T 5/77; G06T 5/73; G06T 5/94; G06T 2207/20016; G06T 2207/20192

(57) ABSTRACT

Systems, circuits, and methods are described for restoring image detail affected by tone mapping or dynamic-range compression. In an example, detail information is extracted at multiple spatial scales from image data in different processing domains, including a raw-domain stage and a luma-domain stage. Coarser detail information may be generated from lower-resolution raw-domain image data, while finer detail information may be generated from higher-resolution luma-domain image data. The coarser detail information may be conditioned for use with the finer detail information, and the resulting detail information may be fused to generate a multi-scale detail map. The multi-scale detail map may be used to restore or enhance image data after tone mapping. In some examples, guided filtering, tone-mapping-aware variance normalization, overlap-aware fusion, segmentation-aware weighting, or synchronization buffering may be used to improve detail preservation, reduce visual artifacts, or reduce hardware memory requirements.

### BACKGROUND

Cameras are optical systems that capture and record light to create images. A camera can include components such as lenses, sensors, and processing units that process the signals captured by the sensors. In some examples, a sensor may generate image data having a dynamic range, color format, resolution, bit depth, noise profile, or characteristic that differs from a format suitable for display, storage, transmission, or further processing.

### BRIEF DESCRIPTION OF THE DRAWINGS

Examples will be readily understood by the following detailed description in conjunction with the accompanying drawings. To facilitate this description, like reference numerals designate like structural elements. Examples are illustrated by way of example, and not by way of limitation, in the figures of the accompanying drawings.

FIG. 1 illustrates an imaging system having detail restoration, according to some examples of the disclosure.

FIG. 2 is a flowchart illustrating a method for restoring details, according to some examples of the disclosure.

FIG. 3 illustrates a multi-scale filtering structure to generate a detail map, according to some examples of the disclosure.

FIG. 4 is a flowchart illustrating a method for performing global tone mapping aware guided filtering to generate edge-preserving smooth image data, according to some examples of the disclosure.

FIG. 5 is a flowchart illustrating a method for bridge conditioning, according to some examples of the disclosure.

FIG. 6 is a flowchart illustrating a method for image processing, according to some examples of the disclosure.

FIG. 7 is a block diagram of an example computing device, according to some examples of the disclosure.

### DETAILED DESCRIPTION

### Overview

An imaging system can include a sensor, and an image processing unit that processes the signals captured by the sensor. The sensor may capture a raw image, and the image processing unit may receive the raw image and produce a processed image. Image processing units may perform various operations on image data generated by the sensor. For example, image processing units may perform correction, noise reduction, demosaic, color conversion, tone mapping, enhancement, compression, or formatting operations. In some examples, such operations may affect local contrast, texture, edge information, or image details. Accordingly, image processing techniques may be used to preserve, restore, or enhance image details while balancing image quality, processing latency, memory usage, circuit area, or power consumption.

Tone mapping and dynamic-range compression can make sensor data suitable for display, storage, or later processing, but these operations may attenuate low-contrast structure and fine texture. This effect is especially relevant in high-dynamic-range imaging, where a sensor may capture local details that are later compressed, quantized, or suppressed by image signal processing. Conventional detail enhancement approaches can recover some local contrast, but a single spatial scale may trade off fine texture preservation against halo artifacts, while a straightforward multi-scale implementation can require substantial buffering, memory bandwidth, circuit area, and power.

The described approach uses a multi-scale detail restoration architecture that extracts detail information before tone mapping and restores or enhances that information after tone mapping. Rather than treating all details in a single processing domain, the architecture separates detail extraction across processing stages. Coarser detail information can be extracted from raw-domain image data at lower resolutions, while finer detail information can be extracted from luma-domain image data at higher resolutions. This split allows large-scale structure to be captured early in the pipeline with lower memory cost, while fine-scale texture can be derived later from cleaner, processed luma data.

A raw-domain coarse detail path generates one or more coarse detail layers from coarse scale images. For example, raw-domain image data may be downscaled to lower-resolution scale images, and guided filtering may be applied to generate edge-preserving base images. A coarse detail layer may then be generated from the difference between a coarse scale image and its corresponding base image. Performing this work before demosaic can reduce the amount of data that must be buffered because the image data may still be represented in a single-component raw or Bayer format.

A luma-domain fine detail path generates one or more fine detail layers from fine scale images produced from luma-domain image data. These fine detail layers may correspond to higher-resolution spatial content, such as texture, hair, foliage, or small image structures. Processing these fine layers after demosaic, color processing, or noise reduction can improve image quality by reducing noise amplification while preserving details that are better represented in the luma domain.

Because the coarse and fine detail information may be generated in different domains and at different resolutions, a bridge conditioning stage prepares the coarse detail information for fusion with the fine detail information. The conditioning may include scale conversion, spatial alignment, domain normalization, luminance correction, clamping, or parameterized weighting. This allows raw-domain coarse detail layers to be converted into a conditioned coarse detail map that is compatible with downstream luma-domain fusion.

The architecture may use multiple guided filter circuits across the different scales. Each guided filter can generate an edge-preserving base image for a corresponding scale image and a detail layer based on the difference between the scale image and the base image. Different guided filter parameters may be used at different scales, including support-window size, coefficient-smoothing-window size, threshold curve, variance-normalization parameter, or detail-power parameter. In some implementations, the local variance support window and the coefficient-smoothing support window may differ, which can reduce effective buffering or support cost while maintaining useful edge-preserving behavior.

The guided filtering may also include tone-mapping-aware variance normalization. Instead of using a fixed local variance threshold that is independent of later tone mapping, the filter may normalize local variance, a variance threshold, or both based on a tone mapping function. This allows detail extraction to account for whether downstream tone mapping is expected to compress or expand contrast in particular luminance regions, improving detail preservation while reducing over-enhancement artifacts.

Detail layers from multiple scales may be fused in a coarse-to-fine order. A lower-resolution detail layer may be upscaled before being fused with a higher-resolution detail layer, and the fusion may reduce overlap contributions between adjacent detail layers. For example, when adjacent detail layers have the same sign at a pixel location, the fusion process may reduce a same-phase overlap contribution so that duplicated detail energy is not over-amplified. This overlap-aware fusion helps preserve multi-scale structure without introducing excessive local contrast or halo-like artifacts.

The resulting multi-scale detail map can be used to generate restored image data. For example, a detail restoration stage may generate a detail factor from the detail map and apply the detail factor to tone-mapped image data derived from the luma-domain image data. This permits detail information extracted before tone mapping to be reintroduced after tone mapping, so that structures attenuated by dynamic-range compression can be restored in the displayed or output image.

Additional control paths can adapt the amount of detail restoration to image content. A segmentation-aware weighting circuit may generate one or more power maps from a segmentation map and use those power maps to modulate coarse or fine detail layers. This allows the system to apply different enhancement strengths to different semantic regions, such as reducing high-frequency enhancement on skin while preserving stronger texture enhancement for foliage, hair, or detailed regions.

The architecture can also include synchronization features that support efficient hardware implementation. Because the coarse detail path may be tapped early in the raw-domain portion of the image processing path while the fine detail path receives later luma-domain data, a synchronization buffer may compensate for delay mismatch between the coarse detail extraction path and the downstream path that supplies luma data. Positioning such buffering before demosaic can preserve the memory advantage of buffering raw-domain data rather than multi-component downstream image data.

The techniques are applicable to image signal processors, camera systems, mobile imaging devices, automotive cameras, client computing devices, and other imaging systems that perform tone mapping, dynamic-range compression, or detail enhancement. The architecture may be implemented in hardware, firmware-controlled hardware, programmable image processing circuits, or a combination of fixed-function and programmable processing resources.

The approach improves detail preservation across multiple spatial frequencies while reducing the hardware cost normally associated with multi-scale filtering. The split raw-domain and luma-domain design reduces line-buffer and synchronization overhead, guided filtering provides edge-preserving detail extraction, tone-mapping-aware normalization aligns extraction with later image compression behavior, and overlap-aware or segmentation-aware weighting improves visual quality by reducing artifacts and adapting enhancement to image content.

As used herein, “image data” can refer to data representing an image, a frame of video, a portion of an image, a portion of a video frame, one or more pixels, one or more pixel groups, one or more image channels, one or more image planes, or one or more values derived from captured light.

As used herein, “raw-domain image data” can refer to image data in a sensor-associated domain before completion of one or more downstream color reconstruction, color conversion, luma-generation, or display-formatting operations. Raw-domain image data can include Bayer image data, color-filter-array image data, monochrome sensor image data, quad Bayer image data, non-Bayer mosaic image data, partially corrected sensor image data, downscaled sensor image data, or image data derived from any of the foregoing.

As used herein, “Bayer domain image data” can refer to raw-domain image data arranged according to a Bayer color filter pattern or a Bayer-derived representation. Bayer domain image data can include full-resolution Bayer image data, downscaled Bayer image data, corrected Bayer image data, compressed Bayer image data, decompressed Bayer image data, or data derived from Bayer-patterned sensor samples before demosaic.

As used herein, “luma-domain image data” can refer to image data that includes, represents, approximates, or is derived from luminance or luma information. Luma-domain image data can include a Y component of YUV image data, a luminance value derived from RGB image data, grayscale image data, a luma approximation generated from raw-domain image data, a downscaled luma image, or image data in a processing domain used to represent intensity separate from, or in relation to, chroma information.

As used herein, “scale image” can refer to image data corresponding to a spatial scale, resolution, sampling density, frequency band, or pyramid level. A scale image can be generated by downscaling, upscaling, filtering, decimating, interpolating, resampling, binning, or selecting image data.

As used herein, “coarse scale image” can refer to a scale image associated with lower spatial resolution, lower spatial frequency, larger spatial support, larger image structures, or coarser detail information relative to at least one further scale image.

As used herein, “fine scale image” can refer to a scale image associated with higher spatial resolution, higher spatial frequency, smaller spatial support, smaller image structures, or finer detail information relative to at least one further scale image.

As used herein, “detail layer” can refer to image data representing local contrast, texture, edge-adjacent information, spatial-frequency content, structural variation, or a difference between input image data and filtered image data. A detail layer can be generated additively, subtractively, multiplicatively, as a ratio, as a gain map, as a residual map, or as a normalized detail representation.

As used herein, “coarse detail layer” can refer to a detail layer generated from a coarse scale image, raw-domain image data, downscaled image data, or image data associated with relatively low spatial-frequency detail.

As used herein, “fine detail layer” can refer to a detail layer generated from a fine scale image, luma-domain image data, higher-resolution image data, or image data associated with relatively high spatial-frequency detail.

As used herein, “detail map” can refer to image data representing detail information from one or more detail layers. A detail map can include a fused detail map, a multi-scale detail map, a coarse detail map, a conditioned coarse detail map, a fine detail map, a normalized detail map, a detail-factor map, or data used to restore or enhance image detail.

As used herein, “coarse detail map” can refer to a detail map generated from one or more coarse detail layers. A coarse detail map can represent raw-domain coarse detail information, downscaled coarse detail information, fused coarse detail information, normalized coarse detail information, or coarse detail information prepared for later fusion.

As used herein, “conditioned coarse detail map” can refer to a coarse detail map that has been processed for use with one or more fine detail layers or luma-domain image data. Conditioning can include scale conversion, spatial alignment, domain normalization, luminance correction, clamping, floor application, parameterized weighting, segmentation-based weighting, gain adjustment, interpolation, filtering, or fixed-point formatting.

As used herein, “bridge conditioning” can refer to processing that adapts detail information generated in one processing domain, scale, timing domain, or data format for use in another processing domain, scale, timing domain, or data format. Bridge conditioning can include one or more operations applied between raw-domain coarse detail extraction and luma-domain fine detail extraction or fusion.

As used herein, “guided filtering” can refer to edge-preserving filtering in which output image data is generated based on local statistics of guide image data. The guide image data can be the same as input image data, different from input image data, or derived from input image data.

As used herein, “edge-preserving base image” can refer to filtered image data in which one or more image details are smoothed while one or more edges, contrast transitions, structures, or high-variance regions are at least partially preserved. An edge-preserving base image can be generated using guided filtering, bilateral filtering, anisotropic diffusion, domain transform filtering, weighted least squares filtering, or a filter having edge-preserving behavior.

As used herein, “tone-mapping-aware variance normalization” can refer to normalization of a local variance, a variance threshold, a filtering decision value, a guided-filter coefficient, or a detail-preservation parameter based at least in part on a tone mapping function, tone mapping curve, tone mapping gain, luma value, luminance value, exposure value, dynamic-range compression value, or calibration value associated with tone mapping.

As used herein, “fusion” can refer to combining two or more detail layers, detail maps, scale images, conditioned maps, or values derived therefrom. Fusion can include summation, weighted summation, blending, overlap reduction, sign-based combination, coarse-to-fine accumulation, normalization, clamping, interpolation, or gain-controlled combination.

As used herein, “overlap contribution” can refer to a portion of detail information represented by two or more detail layers or detail maps. An overlap contribution can be estimated based on magnitude, sign, phase relationship, correlation, spatial alignment, frequency-band relationship, local energy, or a function of adjacent detail layers.

As used herein, “detail factor” can refer to a value, map, multiplier, gain, correction factor, or normalized detail representation used to modify image data based on detail information. A detail factor can be applied to tone-mapped image data, color image data, luma image data, RGB image data, YUV image data, or one or more image channels.

As used herein, “restored image data” can refer to image data generated by modifying image data based on extracted detail information. Restored image data can include enhanced image data, detail-reinjected image data, tone-mapped image data modified by a detail factor, or image data in which local contrast, texture, structure, or spatial-frequency content has been restored or enhanced.

As used herein, “segmentation map” can refer to data representing semantic, spatial, regional, probabilistic, class-based, object-based, material-based, or content-based information associated with image data. A segmentation map can include labels, class probabilities, confidence values, masks, regions, object maps, semantic maps, or values derived from machine-learning processing.

As used herein, “power map” can refer to a spatially varying, scale-dependent, class-dependent, or parameterized set of weights used to modulate detail information. A power map can be generated from a segmentation map, calibration parameters, luma values, spatial position, radial position, user settings, scene information, or image statistics.

As used herein, “synchronization buffer” can refer to memory, registers, line buffers, first-in-first-out storage, delay circuitry, or timing-alignment circuitry used to compensate for delay mismatch between two or more image processing paths or portions of an image processing path.

Example Imaging System with Detail Restoration

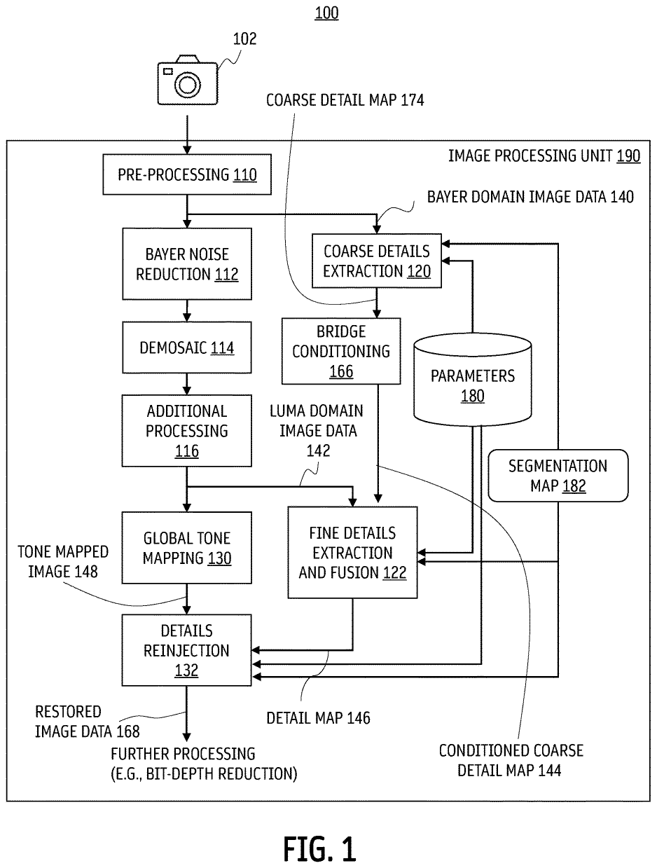

FIG. 1 illustrates imaging system 100 having detail restoration, according to some examples of the disclosure. Imaging system 100 can include camera 102 and image processing unit 190. Camera 102 can include one or more optical elements, one or more image sensors, sensor-control circuitry, readout circuitry, analog-to-digital conversion circuitry, or a combination thereof. Camera 102 can output image data to image processing unit 190. Image processing unit 190 can include an image processing path to process raw-domain image data, such as Bayer domain image data 140, and output luma-domain image data 142. Image processing unit 190 can include one or more of: pre-processing 110, Bayer noise reduction 112, demosaic 114, additional processing 116, global tone mapping 130, details reinjection 132, coarse details extraction 120, bridge conditioning 166, fine details extraction and fusion 122, parameters 180, and segmentation map 182.

In some examples, pre-processing 110 can receive image data from camera 102 and generate Bayer domain image data 140. Bayer domain image data 140 can be raw-domain image data having a color filter array format in which less than all color components are available at each pixel position. Pre-processing 110 can include front-end correction operations, such as black-level correction, lens shading correction, bad-pixel correction, gain control, white-balance adjustment, spatial alignment, linearization, compression-domain conversion, or a combination thereof. Although Bayer domain image data 140 is shown as a raw-domain example, raw-domain image data can include image data represented before demosaic, before full color reconstruction, before luma-domain conversion, or before color-domain image processing that increases the number of components buffered per pixel.

Image processing path can process Bayer domain image data 140 through Bayer noise reduction 112, demosaic 114, and additional processing 116 to generate luma-domain image data 142. Bayer noise reduction 112 can reduce noise while image data remains in raw-domain form. Demosaic 114 can reconstruct color image data from Bayer domain image data 140. Additional processing 116 can include color correction, color space conversion, local tone operations, sharpening, dehaze processing, gamma preparation, format conversion, RGB-to-YUV conversion, luma generation, or a combination thereof. Luma-domain image data 142 can include image data having a luma component generated from demosaiced or color-processed image data. In some examples, luma-domain image data 142 can be used as an input for fine details extraction and fusion 122.

Coarse details extraction 120 can generate one or more coarse detail layers based on one or more coarse scale images generated from Bayer domain image data 140. For example, coarse details extraction 120 can generate lower-resolution scale images from Bayer domain image data 140 and apply one or more edge-preserving filtering operations to extract low-spatial-frequency or coarse-spatial-frequency detail information. Coarse details extraction 120 can output coarse detail map 174, which can represent coarse detail information extracted before demosaic 114 and before generation of luma-domain image data 142. Locating coarse details extraction 120 in raw-domain portion of image processing unit 190 can reduce buffering, bandwidth, and circuit area because coarse detail information can be generated from lower-resolution raw-domain data rather than from higher-volume downstream image data.

In some examples, coarse details extraction 120 can generate one or more coarse detail layers by applying guided filtering to one or more coarse scale images derived from Bayer domain image data 140. Coarse details extraction 120 can generate a lower-resolution raw-domain scale image by downscaling Bayer domain image data 140 and can generate an edge-preserving base image for the lower-resolution raw-domain scale image. Coarse details extraction 120 can then generate a coarse detail layer based on a difference between the lower-resolution raw-domain scale image and the edge-preserving base image. For example, for an input raw-domain scale image I and a corresponding edge-preserving base image B, a coarse detail layer D can be generated based on I-B. The coarse detail layer can represent low-spatial-frequency local contrast, illumination-related structure, object shape, surface shading, or large-scale texture that is present in the raw-domain scale image but smoothed in the edge-preserving base image.

In some examples, coarse details extraction 120 can generate coarse detail layers at multiple raw-domain scales. For example, coarse details extraction 120 can generate a first raw-domain scale image at a first resolution and a second raw-domain scale image at a second resolution higher than the first resolution. A guided filter circuit can generate a first edge-preserving base image for the first raw-domain scale image and a first coarse detail layer based on a difference between the first raw-domain scale image and the first edge-preserving base image. A further guided filter circuit can generate a second edge-preserving base image for the second raw-domain scale image and a second coarse detail layer based on a difference between the second raw-domain scale image and the second edge-preserving base image. In one example, the first raw-domain scale image can be a 1/16-scale image, and the second raw-domain scale image can be a ⅛-scale image.

In some examples, different guided-filter parameters can be used for different coarse scale images. The guided-filter parameters can include a support-window size, a coefficient-smoothing-window size, a threshold curve, a variance-normalization parameter, or a detail-power parameter. For example, coarse details extraction 120 can apply a guided filter having a first support-window size to a 1/16-scale raw-domain image and a guided filter having a second support-window size to a ⅛-scale raw-domain image. Different coarse-scale parameters can allow coarse details extraction 120 to capture large-scale structure while controlling halo formation, over-enhancement, and loss of low-contrast detail near higher-contrast image structures.

In some examples, coarse details extraction 120 can perform overlap-aware fusion to generate coarse detail map 174. For example, coarse details extraction 120 can generate a first coarse detail layer from a lower-resolution raw-domain scale image, upscale the first coarse detail layer, and fuse the upscaled first coarse detail layer with a second coarse detail layer generated from a higher-resolution raw-domain scale image. In one example, coarse details extraction 120 can generate a 1/16-scale coarse detail layer, upscale the 1/16-scale coarse detail layer to a ⅛-scale representation, generate a ⅛-scale coarse detail layer, and fuse the upscaled 1/16-scale coarse detail layer with the ⅛-scale coarse detail layer. Adjacent coarse detail layers can represent partially overlapping frequency content because raw-domain scale images at different resolutions may include related low-spatial-frequency structure. Coarse details extraction 120 can estimate an overlap contribution between adjacent coarse detail layers and subtract at least part of the overlap contribution during fusion. For example, coarse details extraction 120 can determine whether first and second coarse detail values at a pixel location have the same sign. When the signs are the same, such as when same-sign coarse detail values indicate that related coarse structure is represented in both raw-domain scale images, coarse details extraction 120 can calculate a same-phase overlap contribution based on magnitudes of the first and second coarse detail values and subtract the overlap contribution from a sum of the first and second coarse detail values. When the coarse detail values have different signs, coarse details extraction 120 can set the overlap contribution to zero, reduce overlap subtraction, or omit overlap subtraction to preserve cancellation between adjacent scale representations or opposite-phase coarse detail values. Performing overlap-aware fusion within coarse details extraction 120 can reduce over-enhancement of low-spatial-frequency structure before coarse detail map 174 is provided to bridge conditioning 166.

In some examples, coarse details extraction 120 can apply one or more coarse-scale powers before, during, or after fusion of coarse detail layers. A coarse-scale power can be applied to a coarse detail layer generated at a particular raw-domain scale, to an upscaled coarse detail layer, to an intermediate fused coarse detail map, or to coarse detail map 174. The coarse-scale power can be received from parameters 180, derived from segmentation map 182, derived from Bayer domain image data 140, derived from luma-domain image data 142 after alignment, or derived from a combination thereof. Applying coarse-scale powers can allow low-spatial-frequency detail restoration to be tuned separately from fine texture enhancement performed by fine details extraction and fusion 122.

In some examples, coarse details extraction 120 can apply saturation control to one or more coarse detail layers, intermediate fused coarse detail maps, or coarse detail map 174. Saturation control can reduce discontinuities caused by hard clipping when a coarse detail value exceeds a representable range. For example, saturation control can include a first region in which a coarse detail value is passed linearly, a second region in which the coarse detail value is compressed gradually as the coarse detail value approaches a saturation range, and a third region in which the coarse detail value is limited to a saturation value. Gradual saturation can preserve coarse detail fidelity for normal-range values while reducing visible artifacts for large coarse detail values.

In some examples, coarse details extraction 120 can normalize coarse detail map 174 before providing coarse detail map 174 to bridge conditioning 166. For example, coarse details extraction 120 can divide a fused coarse detail value by a corresponding raw-domain intensity value, raw-domain luma approximation, downscaled luma value, Bayer-derived intensity value, or base-image value to generate normalized coarse detail information. A lookup-table-based divider, floor value, clamp value, fixed-point scale value, or calibration parameter from parameters 180 can be used during the normalization. Normalizing coarse detail map 174 can reduce sensitivity to absolute signal level and can prepare raw-domain coarse detail information for later domain matching and fusion with luma-domain fine detail information.

Bridge conditioning 166 can adapt coarse detail map 174 generated in a raw-domain processing stage for use by a later luma-domain processing stage. Bridge conditioning 166 can output conditioned coarse detail map 144 based on coarse detail map 174. Bridge conditioning 166 can apply one or more of scale conversion, spatial alignment, domain normalization, luminance correction, and parameterized weighting to one or more coarse detail layers represented by coarse detail map 174. For example, bridge conditioning 166 can perform one or more of: upscaling coarse detail map 174, aligning coarse detail map 174 with luma-domain image data 142, compensating for differences between raw-domain luminance and luma-domain luminance, applying a clamp or floor value, and applying a gain or power value received from parameters 180. Bridge conditioning 166 can convert raw-domain coarse detail information into conditioned coarse detail map 144 suitable for fusion with one or more luma-domain fine detail layers.

Fine details extraction and fusion 122 can be coupled to image processing path to generate one or more fine detail layers based on one or more fine scale images generated from luma-domain image data 142. Fine details extraction and fusion 122 can process luma-domain image data 142 at one or more resolutions, such as full resolution, half resolution, quarter resolution, or a combination thereof. Fine details extraction and fusion 122 can also receive conditioned coarse detail map 144 from bridge conditioning 166 and fuse conditioned coarse detail map 144 with one or more fine detail layers to output detail map 146. Processing fine detail information in luma domain can improve detail extraction quality because luma-domain image data 142 can reflect denoising, demosaic, color processing, and luma generation performed along image processing path.

In some examples, fine details extraction and fusion 122 can reduce overlap between detail information contributed by different scales. Adjacent detail layers can represent partially overlapping frequency content because each guided filter stage may extract detail from a scale image that is not perfectly separated from coarser or finer scale bands. Fine details extraction and fusion 122 can therefore estimate an overlap contribution between adjacent detail layers and subtract at least part of the overlap contribution during fusion. For example, for first and second adjacent detail values at a pixel location, fine details extraction and fusion 122 can determine whether the first and second adjacent detail values have a same sign. When the signs are the same, fine details extraction and fusion 122 can calculate a same-phase overlap contribution based on magnitudes of the adjacent detail values and subtract the overlap contribution from a sum of the adjacent detail values. When the signs differ, fine details extraction and fusion 122 can set the overlap contribution to zero or reduce overlap subtraction so that natural cancellation between opposite-phase detail values is preserved.

In some examples, fine details extraction and fusion 122 can apply one or more scale-specific powers before, during, or after fusion. A scale-specific power can be applied to a coarse detail layer, conditioned coarse detail map 144, a fine detail layer, or an intermediate fused detail map. For example, a full-resolution fine detail layer can be multiplied by a first power value, a ½-scale fine detail layer can be multiplied by a second power value, a ¼-scale fine detail layer can be multiplied by a third power value, or conditioned coarse detail map 144 can be multiplied by a fourth power value. The power values can be received from parameters 180, derived from segmentation map 182, derived from luma-domain image data 142, or derived from a combination thereof. Scale-specific powers can allow fine texture enhancement, mid-scale structure enhancement, and coarse shape enhancement to be tuned independently.

In some examples, fine details extraction and fusion 122 can apply saturation control to one or more detail layers, intermediate fused detail maps, or detail map 146. Saturation control can reduce discontinuities caused by hard clipping when a detail value exceeds a representable range. For example, saturation control can include a first region in which a detail value is passed linearly, a second region in which the detail value is compressed gradually as the detail value approaches a saturation range, and a third region in which the detail value is limited to a saturation value. Gradual saturation can preserve detail fidelity for normal-range detail values while reducing visible artifacts for large detail values.

In some examples, fine details extraction and fusion 122 can normalize one or more fine detail layers, intermediate fused detail maps, or detail map 146 before providing detail map 146 to details reinjection 132. For example, fine details extraction and fusion 122 can divide a fine detail value or fused detail value by a corresponding luma value, scale-image value, edge-preserving base-image value, or floor-limited value to generate normalized fine detail information. A lookup-table-based divider, floor value, clamp value, fixed-point scale value, or calibration parameter from parameters 180 can be used during the normalization. Normalizing within fine details extraction and fusion 122 can reduce sensitivity to absolute luma level, improve compatibility between fine detail layers generated at different scales, and prepare detail map 146 for stable detail-factor generation by details reinjection 132.

In some examples, fine details extraction and fusion 122 can apply a location-dependent correction to detail map 146. The location-dependent correction can include a radial correction multiplier, a lens-position-dependent multiplier, a vignette-dependent multiplier, a tile-dependent multiplier, or a spatial gain map. The location-dependent correction can compensate for spatially varying lens characteristics, sensor characteristics, denoising strength, sharpening strength, tone-mapping behavior, or detail visibility across an image frame. For example, detail values near a frame edge can be multiplied by a different correction value than detail values near a frame center. Location-dependent correction can be applied before generation of a detail factor by details reinjection 132.

In some examples, detail map 146 can be generated by fine details extraction and fusion 122 based on a coarse-to-fine fusion process. Fine details extraction and fusion 122 can receive conditioned coarse detail map 144 and luma-domain image data 142. Fine details extraction and fusion 122 can generate a first fine detail layer at a relatively coarse luma-domain scale, fuse the first fine detail layer with conditioned coarse detail map 144, upscale the resulting fused detail information, generate a second fine detail layer at a higher-resolution luma-domain scale, and fuse the second fine detail layer with the upscaled fused detail information. This process can be repeated for additional fine scale images until full-resolution detail information is generated. For example, conditioned coarse detail map 144 can be fused with a ¼-scale luma detail layer, the resulting detail information can be upscaled and fused with a ½-scale luma detail layer, and the resulting detail information can be upscaled and fused with a full-resolution luma detail layer.

In some examples, a fine detail layer can be generated by applying guided filtering to a scale image derived from luma-domain image data 142. A guided filter circuit can generate an edge-preserving base image for the scale image. Fine details extraction and fusion 122 can then generate the fine detail layer based on a difference between the scale image and the edge-preserving base image. For example, for an input luma scale image I and a corresponding edge-preserving base image B, a detail layer D can be generated based on I-B. This detail layer can represent local contrast, texture, or spatial-frequency content that is present in the input luma scale image but smoothed in the edge-preserving base image. Different fine scale images can use different guided-filter parameters, such as support-window size, coefficient-smoothing-window size, threshold curve, variance-normalization parameter, or detail-power parameter.

For example, fine details extraction and fusion 122 can apply a guided filter having a first support-window size to a ¼-scale luma-domain image, a guided filter having a second support-window size to a ½-scale luma-domain image, or a guided filter having a third support-window size to a full-resolution luma-domain image. Different fine-scale parameters can allow fine details extraction and fusion 122 to capture fine texture and higher-spatial-frequency structure while controlling noise amplification, over-enhancement, halo formation, and loss of low-contrast detail near higher-contrast image structures.

In some examples, coarse details extraction 120, fine details extraction and fusion 122, or both can include one or more guided filter circuits. A guided filter circuit can generate edge-preserving smooth image data, such as an edge-preserving base image, for a corresponding scale image and generate a corresponding detail layer based on a difference between input image data and the edge-preserving smooth image data. Guided filter parameters can be stored in parameters 180 and can include one or more of: support-window size, coefficient-smoothing-window size, threshold curve, variance-normalization parameter, and detail-power parameter. Different guided filter circuits can use different guided filter parameters so that coarse detail extraction and fine detail extraction can be tuned independently for different spatial-frequency bands.

Parameters 180 can store control information for one or more blocks of image processing unit 190. Parameters 180 can include per-domain parameters, per-branch parameters, per-scale parameters, per-segment parameters, or per-frame parameters. Parameters 180 can provide parameters to one or more of coarse details extraction 120, bridge conditioning 166, fine details extraction and fusion 122, and details reinjection 132. Parameters 180 can include one or more of: scale-selection parameters, guided-filter parameters, tone-mapping-aware variance-normalization parameters, overlap-aware fusion parameters, luminance-correction parameters, fixed-point scaling parameters, radial correction parameters, clamping parameters, detail-factor parameters, per-scale weights, semantic-class weights, and calibration tables. In some examples, parameters 180 can include one or more lookup tables that define one or more of luma-dependent normalization values, tone-mapping-dependent variance values, segmentation-to-power mappings, and divider approximations. Parameterizing these functions can allow imaging system 100 to balance detail preservation, artifact suppression, power consumption, line-buffer usage, and tuning flexibility across sensors, image resolutions, tone-mapping curves, and product configurations.

Segmentation map 182 can provide content-dependent control information to image processing unit 190. Segmentation map 182 can identify semantic regions, object classes, material classes, confidence values, or region probabilities associated with image data. Segmentation map 182 need not be limited to semantic labels and can include region, material, object, confidence, saliency, depth-related, face-related, motion-related, or texture-related information. Segmentation map 182, optionally along with parameters 180, can be used to generate one or more power maps that modulate detail restoration at one or more stages. For example, segmentation-aware weighting can reduce fine-detail enhancement for skin regions, increase texture enhancement for foliage or hair regions, reduce enhancement for sky or flat regions, and adjust enhancement near light sources. Segmentation-aware control can therefore adapt detail restoration based on image content while preserving a common multi-scale detail extraction architecture.

In some examples, segmentation map 182 can include a plurality of class channels. Each class channel can correspond to a semantic class, such as skin, face, hair, foliage, sky, road, wall, fabric, text, light source, background, foreground object, flat region, textured region, or an object class detected by a machine-learning model. Each class channel can include a binary mask, a confidence value, a probability value, or a spatially varying score for pixels or pixel groups. Image processing unit 190 can use the class channels to select respective detail-restoration strengths for different spatial locations. For example, a pixel associated with a high skin probability can be assigned a lower fine-detail power, while a pixel associated with a high foliage probability can be assigned a higher fine-detail power.

In some examples, parameters 180 can include one or more segment-to-power lookup tables. A segment-to-power lookup table can map a semantic class, class probability, confidence value, luma value, scale index, or any combination thereof to a power value. The power value can be applied to a coarse detail layer, conditioned coarse detail map 144, a fine detail layer, detail map 146, or a detail factor used by details reinjection 132. For example, parameters 180 can include a first table for coarse detail enhancement and a second table for fine detail enhancement. The first table can assign a relatively higher coarse-detail power to skin regions to preserve face shape and three-dimensional appearance, while the second table can assign a relatively lower fine-detail power to skin regions to reduce enhancement of pores, blemishes, and sensor noise.

In some examples, segmentation-aware weighting utilizing segmentation map 182 can be scale-dependent. A coarse-detail power map can be generated for coarse spatial-frequency detail, and one or more fine-detail power maps can be generated for finer spatial-frequency detail. For example, a hair region can receive moderate coarse-detail power and high fine-detail power to enhance strands and texture. A foliage region can receive high power across multiple scales to enhance leaves and branches. A sky region can receive low power across multiple scales to preserve smooth gradients and reduce banding or noise amplification. A face region can receive higher coarse-detail power and lower fine-detail power so that global facial shape is retained while high-frequency facial texture is not over-emphasized.

In some examples, segmentation-aware weighting utilizing segmentation map 182 can be generated by blending power values from multiple semantic classes. For a pixel or pixel group having probabilities for two or more classes, image processing unit 190 can compute a weighted combination of class-specific power values. For example, a boundary between skin and hair can have both skin probability and hair probability. A power map value near the boundary can be generated by blending a skin-specific power value with a hair-specific power value based on the corresponding probabilities. Probability-based blending can reduce abrupt transitions in detail enhancement at semantic boundaries and can reduce visible seams caused by segmentation uncertainty.

In some examples, segmentation map 182 can be available at a resolution different from a resolution of one or more detail layers. Image processing unit 190 can generate a power map at a segmentation-map resolution and then resample the power map to one or more resolutions used by coarse details extraction 120, bridge conditioning 166, fine details extraction and fusion 122, or details reinjection 132. In some examples, class probabilities can be converted to power values before upscaling so that interpolation is performed on enhancement strengths rather than on class labels. Interpolating enhancement strengths can provide gradual transitions between semantic regions and can reduce artifacts that may arise from upscaling hard segmentation labels.

In some examples, segmentation-aware weighting utilizing segmentation map 182 can be applied at different locations in image processing unit 190, including to a coarse detail layer, conditioned coarse detail map 144, a fine detail layer, detail map 146, or a detail factor used by details reinjection 132. Applying the weighting at different locations can control large-scale shape or illumination-related detail, raw-domain coarse detail after bridge conditioning, texture enhancement at a corresponding spatial scale, aggregate multi-scale detail information, or final restoration strength after tone mapping.

In some examples, segmentation-aware weighting utilizing segmentation map 182 can be combined with luma-dependent, tone-mapping-dependent, or position-dependent control. For example, a light-source region can receive a power value based on both a light-source class probability and a tone-mapping parameter indicating compression of highlight detail. A backlit face region can receive a power value based on a face class probability, local luma, and a tone-mapping gain associated with the region. A flat wall region can receive a low power value when local variance is low to reduce noise enhancement, while a text region can receive a higher power value to preserve edge clarity. These combinations can allow image processing unit 190 to use semantic content together with image statistics and tone-mapping behavior.

In some examples, segmentation map 182 can be generated by a neural-network accelerator, an image processor, a host processor, camera firmware, an application processor, or a remote processing system. Segmentation map 182 can be provided to image processing unit 190 as a full-resolution map, a downscaled map, a tile-based map, a bounding-box representation, a region list, a sparse map, or a compressed representation. Image processing unit 190 can convert the received representation into one or more power maps. In some examples, segmentation map 182 can be updated per frame, per group of frames, per scene, or when a scene-change condition is detected.

In some examples, segmentation-aware weighting utilizing segmentation map 182 can include temporal smoothing. Image processing unit 190 can smooth one or more power maps (or segmentation map 182) across frames, across tiles, or across neighboring pixel regions to reduce flicker caused by frame-to-frame changes in segmentation map 182. For example, a power value for a face region can be filtered over time so that fine-detail enhancement does not abruptly change when a face detector confidence varies between adjacent frames. Temporal smoothing can be applied to class probabilities, class-specific power values, blended power values, or final power map values.

In some examples, segmentation-aware weighting utilizing segmentation map 182 can be selectively enabled or disabled for different scales, regions, or processing stages. Segmentation-aware weighting can influence parameters such as enable values, bypass values, minimum power values, maximum power values, slope values, blending coefficients, saturation limits, or priority values for different semantic classes. For example, if a pixel is associated with both a text class and a flat-region class, a priority value can cause a text-preservation power to dominate a flat-region smoothing power. As another example, a minimum power value can preserve a baseline amount of detail restoration even when a segmentation class indicates low enhancement.

In some examples, a power value of a power map can operate as an enhancement strength value that is applied to a corresponding detail value at a corresponding pixel location or pixel group. For example, after the power map is resampled to a target resolution of a coarse detail layer, conditioned coarse detail map, fine detail layer, detail map, or detail factor, the image processing unit can multiply, scale, attenuate, amplify, or otherwise weight the corresponding detail value using the power value. A power value greater than a baseline value can increase the contribution of the corresponding detail information, a power value less than the baseline value can reduce the contribution of the corresponding detail information, and a power value equal to the baseline value can leave the corresponding detail information substantially unchanged. Thus, the power map can spatially vary the enhancement strength applied to detail information before fusion, during fusion, after fusion, or during generation or application of the detail factor.

In some examples, a power value of a power map can correspond to an enhancement strength applied to a detail value at a corresponding pixel location or pixel group. The image processing unit can resample the power map to a target resolution of a coarse detail layer, conditioned coarse detail map, fine detail layer, detail map, or detail factor, and can use the resampled power value to multiply, scale, attenuate, amplify, or otherwise weight the corresponding detail value. Applying the power value in this manner allows segmentation-aware weighting to control how strongly detail information from a particular semantic region contributes before fusion, during fusion, after fusion, or during generation or application of the detail factor.

Global tone mapping 130 can generate tone mapped image 148 based on image data derived from luma-domain image data 142. Tone mapped image 148 can include image data whose dynamic range, contrast distribution, bit depth, or display range has been modified by a tone mapping function. In some examples, global tone mapping 130 can compress high-dynamic-range image data into a range suitable for display, storage, encoding, or subsequent image processing. Detail map 146 can include detail information extracted before global tone mapping 130 would remove, compress, attenuate, or quantize at least part of such detail information. Details reinjection 132 can generate restored image data 168 based on detail map 146 and tone mapped image 148.

Details reinjection 132 can generate a detail factor based on detail map 146. In some examples, details reinjection 132 can generate a base image from luma-domain image data 142 and detail map 146. For example, base image can be generated based on a difference between luma-domain image data 142 and detail map 146. Details reinjection 132 can generate the detail factor based on a ratio between detail map 146 and the base image. For example, the detail factor can correspond to one plus a normalized detail value, where the normalized detail value is based on detail map 146 divided by the base image. A floor value can be applied to the base image before division to reduce instability at low luma values, and a clamp can be applied to the normalized detail value or to the detail factor to keep the result within a selected numerical range.

In some examples, details reinjection 132 can use one or more lookup-table-based operations to generate the detail factor. For example, details reinjection 132 can use a lookup-table-based divider to approximate division of detail map 146 by the base image. Details reinjection 132 can also use a calibration-controlled luma normalization function to modify the normalized detail value based on a luma value of the base image. The luma normalization function can be represented by parameters 180 and can allow different restoration strengths in shadow regions, midtone regions, and highlight regions. For example, parameters 180 can cause details reinjection 132 to preserve more subtle texture in relatively dark regions, apply stronger enhancement in relatively bright regions, or apply a more uniform detail amplitude across a luminance range.

In some examples, the detail factor can be represented in a fixed-point format. For example, a unity gain can be represented by a fixed-point value, such as 214, and a normalized detail component can be added to the fixed-point unity gain to generate the detail factor. After details reinjection 132 applies the detail factor to tone mapped image 148, details reinjection 132 can shift or scale the multiplied result to return the result to a selected output format. Fixed-point representation can reduce hardware complexity relative to floating-point operations while providing sufficient precision for real-time image processing.

In some examples, details reinjection 132 can apply the detail factor to tone mapped image 148 to generate restored image data 168. In some examples, details reinjection 132 can multiply each of a plurality of color components of tone mapped image 148 by the same detail factor at a corresponding pixel location. For example, details reinjection 132 can multiply red, green, and blue components of tone mapped image 148 by a common detail factor generated from luma-domain detail information. Applying a common detail factor to multiple color components can restore local contrast while reducing chroma shifts. In some examples, details reinjection 132 can apply different component-specific factors to different color components when color-dependent restoration is desired.

Details reinjection 132 can generate a detail factor based on detail map 146. In some examples, details reinjection 132 can receive luma-domain image data 142, represented as Yin, and detail map 146, represented as Details. Details reinjection 132 can generate a base image based on a difference between Yin and Details. For example, details reinjection 132 can generate the base image according to:

base_image = Yin − Details

The base image can represent an estimate of image content after removal of detail information represented by detail map 146. Generating the base image by subtracting Details from Yin can provide a reference value for normalizing detail information before the detail information is applied to tone mapped image 148.

In some examples, details reinjection 132 can generate a normalized detail value based on a ratio between Details and base_image. For example, details reinjection 132 can generate the normalized detail value according to:

normalized_detail = Details / base_image

In some examples, details reinjection 132 can apply a floor value to base_image before division so that the denominator does not fall below a selected minimum value. Details reinjection 132 can also clamp normalized_detail to a minimum value, a maximum value, or a selected fixed-point range. The floor and clamp operations can reduce numerical instability in low-luma regions and can limit excessive restoration strength.

In some examples, details reinjection 132 can modify normalized_detail using a calibration-controlled luma normalization function. For example, details reinjection 132 can generate a luma-normalized detail value according to:

luma_normalized_detail = normalized_detail ·
cu_luma_norm(base_image)

The function cu_luma_norm (base_image) can be represented by one or more values stored in parameters 180. For example, cu_luma_norm (base_image) can be implemented as a lookup table indexed by base_image, a luma value, a tone-mapping-related value, or a quantized range of such values. The luma normalization function can allow details reinjection 132 to apply different restoration strengths in shadow regions, midtone regions, and highlight regions.

In some examples, details reinjection 132 can generate the detail factor by adding a unity term to the luma-normalized detail value. For example, details reinjection 132 can generate the detail factor according to:

DF = 1 + luma_normalized_detail

Accordingly, the detail factor can be greater than unity at pixel locations where detail map 146 indicates positive detail, less than unity at pixel locations where detail map 146 indicates negative detail, and approximately unity at pixel locations where detail map 146 indicates little or no detail. In a fixed-point implementation, the unity term can be represented by a fixed-point value, such as 214, and the luma-normalized detail value can be represented in the same fixed-point domain before addition.

In some examples, details reinjection 132 can apply the detail factor to tone mapped image 148 to generate restored image data 168. For example, for a tone-mapped color component C_GTM of tone mapped image 148, details reinjection 132 can generate a restored color component C_REST according to:

C_REST = C_GTM · DF

When fixed-point values are used, details reinjection 132 can multiply C_GTM by DF and then apply a shift, scaling operation, rounding operation, or clamp operation to return the result to a selected output range. In some examples, the same detail factor can be applied to multiple color components at a corresponding pixel location, such as red, green, and blue components. Applying a common detail factor to multiple color components can restore local contrast while reducing chroma shifts. In some examples, component-specific detail factors can be generated when color-dependent restoration is used.

In some examples, details reinjection 132 can implement one or more of the division, luma normalization, unity addition, multiplication, shifting, scaling, rounding, and clamping operations using fixed-function arithmetic, lookup tables, approximation circuitry, programmable circuitry, or firmware-controlled hardware. For example, details reinjection 132 can use a lookup-table-based divider to approximate Details/base_image, a lookup table stored in parameters 180 to provide cu_luma_norm (base_image), and fixed-point arithmetic to generate DF. These operations can allow details reinjection 132 to restore detail information extracted before global tone mapping 130 while applying the restoration to tone mapped image 148.

In some examples, details reinjection 132 can apply detail map 146 at a processing point after global tone mapping 130, before bit-depth reduction, before gamma processing, before compression, before display formatting, or at a selected downstream point in image processing unit 190. Applying detail restoration after global tone mapping 130 allows details extracted from pre-tone-mapped image data to be reintroduced into an image whose dynamic range has already been compressed. Applying detail restoration before later bit-depth reduction can preserve restored details that could be lost if reinjection were delayed until after quantization.

In some examples, global tone mapping 130 and bit-depth reduction can be implemented as separate processing operations rather than as a single combined global tone mapping operation. For example, global tone mapping 130 can generate tone mapped image 148 at a higher bit depth or in a higher-precision representation, and details reinjection 132 can apply detail map 146 or a detail factor to the higher-precision tone mapped image 148 before bit-depth reduction, quantization, gamma processing, compression, or display formatting is performed. In such examples, tone mapped image 148 can remain unquantized, or can retain more precision than a final output image, when detail restoration is applied. Separating tone mapping from later bit-depth reduction can allow detail information that was extracted before tone mapping and restored after tone mapping to be represented with greater numerical precision before quantization. This ordering can reduce loss of restored low-contrast texture, reduce contouring or banding introduced by quantizing before detail reinjection, preserve more accurate local contrast in shadow, midtone, or highlight regions, and thereby improve perceived image quality relative to an implementation in which tone mapping, detail restoration, and bit-depth reduction are performed as a single combined or differently ordered operation.

In some examples, image processing unit 190 can include one or more synchronization buffers to adjust timing between coarse details extraction 120 and a downstream portion of the image processing path that supplies luma-domain image data 142 to fine details extraction and fusion 122. For example, a synchronization buffer can delay raw-domain image data, Bayer domain image data 140, coarse-detail-related data, conditioned coarse detail map 144, luma-domain image data 142, a control signal, or a parameter value so that data generated along different portions of image processing unit 190 is available for a corresponding bridge conditioning, fusion, or details reinjection operation. A synchronization buffer can be positioned before demosaic 114, after demosaic 114, within bridge conditioning 166, within fine details extraction and fusion 122, or at another point along a data path between coarse details extraction 120 and fine details extraction and fusion 122. Positioning a synchronization buffer in a raw-domain portion of image processing unit 190 can reduce buffer size, bandwidth, or line-buffer requirements in implementations where downstream image data includes multiple components or higher data volume.

Image processing unit 190 can provide restored image data 168 from details reinjection 132 to further processing. Further processing can include gamma correction, color formatting, compression, scaling, display processing, video encoding, storage formatting, transmission formatting, machine-vision processing, or a combination thereof. By extracting coarse detail information from Bayer domain image data 140, conditioning that coarse detail information for luma-domain fusion, extracting fine detail information from luma-domain image data 142, and applying detail map 146 to tone mapped image 148, imaging system 100 can preserve multi-scale detail while reducing memory requirements associated with performing all detail extraction after demosaic 114. Imaging system 100 can support tuning and product-specific calibration through parameters 180 and segmentation map 182 without requiring a different image processing path architecture.

Although FIG. 1 illustrates an example in which coarse details extraction 120 receives Bayer domain image data 140 and fine details extraction and fusion 122 receives luma-domain image data 142, the arrangement of FIG. 1 is not limited to a particular camera pipeline format or a particular ordering of image processing blocks. In some examples, coarse details extraction 120 can receive image data from a raw-domain stage, a color-filter-array stage, a monochrome sensor stage, a partially processed sensor stage, a downscaled sensor-data stage, a pre-demosaic stage, a post-demosaic stage, or a stage that precedes one or more tone mapping, color conversion, gamma, compression, or bit-depth reduction operations. Fine details extraction and fusion 122 can receive image data from a luma stage, a luminance-derived stage, an RGB stage, a YUV stage, a grayscale stage, a post-demosaic stage, a post-denoise stage, or a stage that provides image data suitable for extracting finer spatial-frequency detail.

In some examples, the respective locations of coarse details extraction 120 and fine details extraction and fusion 122 can be selected based on image quality, memory, latency, bandwidth, power, or circuit-area considerations for a particular image processing pipeline. For example, coarse details extraction 120 can be positioned at a stage where image data has a reduced number of components per pixel, a lower spatial resolution, a lower data rate, a lower bit depth, an available downscaled representation, or access to line buffers used by another image processing block. Fine details extraction and fusion 122 can be positioned at a stage where image data has reduced noise, improved color reconstruction, improved luma estimation, improved spatial registration, or a representation better suited to preserving high-spatial-frequency detail.

In some examples, image processing unit 190 can use more than two detail-extraction domains. For example, image processing unit 190 can generate one or more coarse detail layers from raw-domain image data, one or more intermediate detail layers from RGB-domain or color-corrected image data, and one or more fine detail layers from luma-domain image data. Bridge conditioning 166 can be used between any two such domains to adapt detail information generated at one stage for use at another stage. Accordingly, bridge conditioning 166 can condition detail information generated before demosaic 114, after demosaic 114, before color correction, after color correction, before global tone mapping 130, after global tone mapping 130, or at a selected point in image processing unit 190.

In some examples, coarse details extraction 120, bridge conditioning 166, fine details extraction and fusion 122, global tone mapping 130, and details reinjection 132 need not be implemented as separate physical circuit blocks. One or more of these operations can be implemented by shared hardware, a programmable image processor, firmware-controlled circuitry, a digital signal processor, a graphics processor, a neural-network accelerator, fixed-function circuitry, or a combination thereof. For example, a shared filtering circuit can perform guided filtering for different scale images at different times, a shared scaling circuit can generate scale images for multiple processing blocks, or a shared memory controller can provide image data to coarse details extraction 120 and another image processing operation.

In some examples, the number of scale images and detail layers can differ from the example shown in FIG. 1. Image processing unit 190 can generate one detail layer, two detail layers, three detail layers, four detail layers, five detail layers, or more than five detail layers. The detail layers can include any number of coarse detail layers and any number of fine detail layers. A scale image can correspond to a full-resolution image, a fractional-resolution image, a tiled image, a binned image, a subsampled image, a filtered image, or an image pyramid level. Scale factors can include powers of two, non-powers of two, anisotropic scale factors, sensor-binning ratios, tile-dependent scale factors, or scale factors selected based on available hardware resources.

In some examples, detail restoration and enhancement can be applied at different positions relative to tone mapping. Details reinjection 132 can apply detail map 146 to image data after global tone mapping 130, before global tone mapping 130, between multiple tone mapping operations, after local tone mapping, before bit-depth reduction, after bit-depth reduction with a corresponding scale adjustment, before gamma processing, after gamma processing, before compression, or before display formatting. In examples having multiple tone mapping operations, detail map 146 can be generated before a first tone mapping operation and applied after a later tone mapping operation, or different detail maps can be generated and applied at different stages.

In some examples, image processing unit 190 can process still images, video frames, burst-image sequences, multi-exposure image data, high-dynamic-range image data, low-light image data, monochrome image data, multispectral image data, infrared image data, depth-associated image data, or image data from multiple cameras. When multiple image streams are processed, coarse details extraction 120, bridge conditioning 166, fine details extraction and fusion 122, or details reinjection 132 can operate on one image stream, multiple image streams independently, a fused image stream, a reference image stream, or image data generated by combining image streams.

### Example Detail Restoration Process

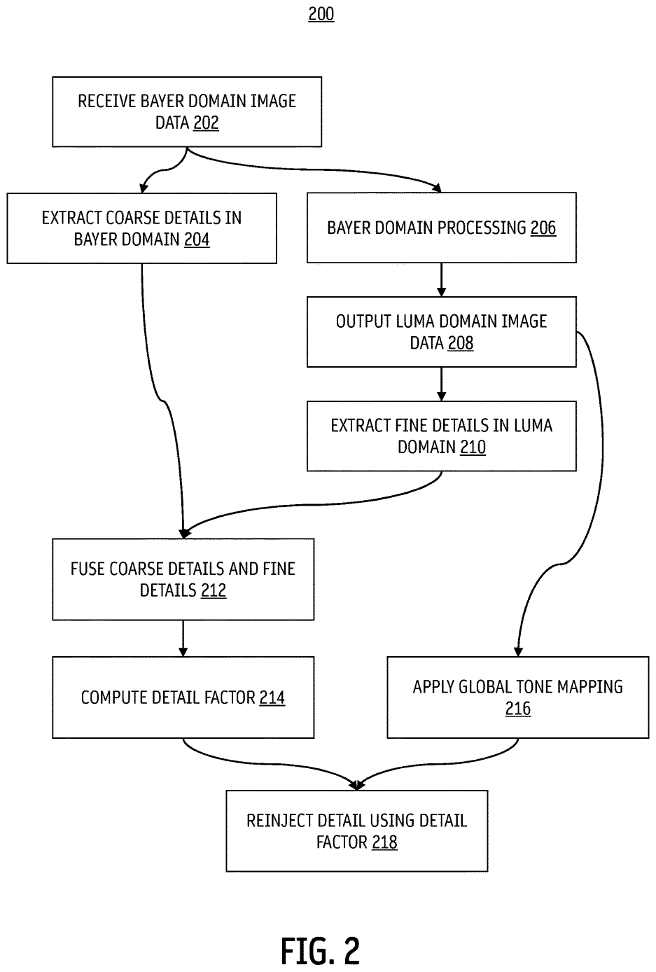

FIG. 2 is a flowchart illustrating method 200 for restoring details, according to some examples of the disclosure. Method 200 can be performed by imaging system 100, image processing unit 190, one or more circuits of image processing unit 190, one or more processors, one or more hardware accelerators, firmware-controlled circuitry, or a combination thereof. Although FIG. 2 illustrates operations in a particular order, one or more operations of method 200 can be performed in a different order, omitted, repeated, or performed at least partially in parallel, unless a particular order is required by data dependency.

In 202, image processing unit 190 can receive Bayer domain image data.

Performing 202 can include receiving Bayer domain image data 140 from camera 102, pre-processing 110, sensor-interface circuitry, memory, or a preceding image processing stage. In some examples, Bayer domain image data 140 can be an example of raw-domain image data and can include image data represented before demosaic 114, before full color reconstruction, or before generation of luma-domain image data 142. Receiving Bayer domain image data 140 can provide an input stream that is used by both a coarse-detail path and a main image processing path.

In 204, coarse details extraction 120 can extract coarse details in Bayer domain. Performing 204 can include generating one or more coarse scale images from Bayer domain image data 140, applying one or more edge-preserving filtering operations to the one or more coarse scale images, and generating one or more coarse detail layers based on differences between the one or more coarse scale images and corresponding edge-preserving base images. In some examples, performing 204 can include downscaling Bayer domain image data 140 to generate 1/16-scale and ⅛-scale raw-domain scale images, applying guided filtering to the scale images, upscaling a lower-resolution coarse detail layer, and fusing the upscaled lower-resolution coarse detail layer with a higher-resolution coarse detail layer to generate coarse detail map 174. Extracting coarse details in Bayer domain can allow lower-spatial-frequency detail to be extracted while image data remains in a raw-domain representation.

In 206, image processing unit 190 can perform Bayer domain processing.

Performing 206 can include processing Bayer domain image data 140 along an image processing path separate from, or at least partially parallel with, coarse details extraction 120. In some examples, performing 206 can include Bayer noise reduction 112, demosaic 114, front-end correction, raw-domain filtering, color reconstruction, color correction preparation, or processing that converts Bayer domain image data 140 toward a luma-domain representation. As shown in FIG. 2, Bayer domain processing in 206 can proceed from the image data received in 202 while coarse details are extracted in 204, allowing coarse-detail generation and main-path image processing to be performed using related input image data.

In 208, image processing unit 190 can output luma domain image data.

Performing 208 can include generating luma-domain image data 142 from data processed in 206. In some examples, luma-domain image data 142 can be generated after demosaic 114, additional processing 116, color correction, color space conversion, RGB-to-YUV conversion, luma generation, denoising, or format conversion. Outputting luma-domain image data 142 can provide image data for extracting finer spatial-frequency details and can also provide image data from which tone mapped image 148 is later generated.

In 210, fine details extraction and fusion 122 can extract fine details in luma domain. Performing 210 can include generating one or more fine scale images from luma-domain image data 142, applying one or more guided filter circuits to the one or more fine scale images, and generating one or more fine detail layers based on differences between the one or more fine scale images and corresponding edge-preserving base images. In some examples, performing 210 can include generating fine detail layers at ¼-scale, ½-scale, and full-resolution luma-domain scales. Extracting fine details in luma domain can allow fine texture information to be generated from image data that has undergone one or more upstream processing operations.

In 212, fine details extraction and fusion 122 can fuse coarse details and fine details. Performing 212 can include receiving coarse detail information generated in 204 and fine detail information generated in 210 and generating detail map 146 based on the coarse detail information and the fine detail information. In some examples, bridge conditioning 166 can condition coarse detail map 174 before fusion by applying one or more of scale conversion, spatial alignment, domain normalization, luminance correction, and parameterized weighting to output conditioned coarse detail map 144. Fine details extraction and fusion 122 can then fuse conditioned coarse detail map 144 with one or more fine detail layers. Performing 212 can include upscaling a lower-resolution detail layer, fusing the upscaled lower-resolution detail layer with a higher-resolution detail layer, reducing an overlap contribution between adjacent detail layers, applying scale-specific powers, applying segmentation-aware weights, or applying saturation control.

In 214, details reinjection 132 can compute a detail factor. Performing 214 can include generating a detail factor based on detail map 146. In some examples, details reinjection 132 can generate a base image based on luma-domain image data 142 and detail map 146, normalize detail map 146 based on the base image, apply a floor value or clamp value, apply a luma normalization function from parameters 180, and add a unity value to generate the detail factor. Computing the detail factor can convert additive or residual detail information represented by detail map 146 into a multiplicative gain representation suitable for application to tone mapped image 148.

In 216, global tone mapping 130 can apply global tone mapping. Performing 216 can include applying a tone mapping function to image data derived from luma-domain image data 142 to generate tone mapped image 148. In some examples, applying global tone mapping can compress dynamic range, modify contrast distribution, reduce bit depth, map image data to a display-compatible range, or prepare image data for downstream formatting. As shown in FIG. 2, applying global tone mapping in 216 can be performed on a main image path while detail factor computation in 214 is performed based on detail information extracted before tone mapping.

In 218, details reinjection 132 can reinject detail using the detail factor.

Performing 218 can include applying the detail factor computed in 214 to tone mapped image 148 generated in 216 to generate restored image data 168. In some examples, details reinjection 132 can multiply one or more color components of tone mapped image 148 by the detail factor, apply a fixed-point shift or scaling operation, or clamp the result to a selected output range. Reinjecting detail using the detail factor can restore or enhance detail information that was extracted before tone mapping and then applied to image data after tone mapping.

### Example Multi-Scale Filtering Structure for Detail Map Generation

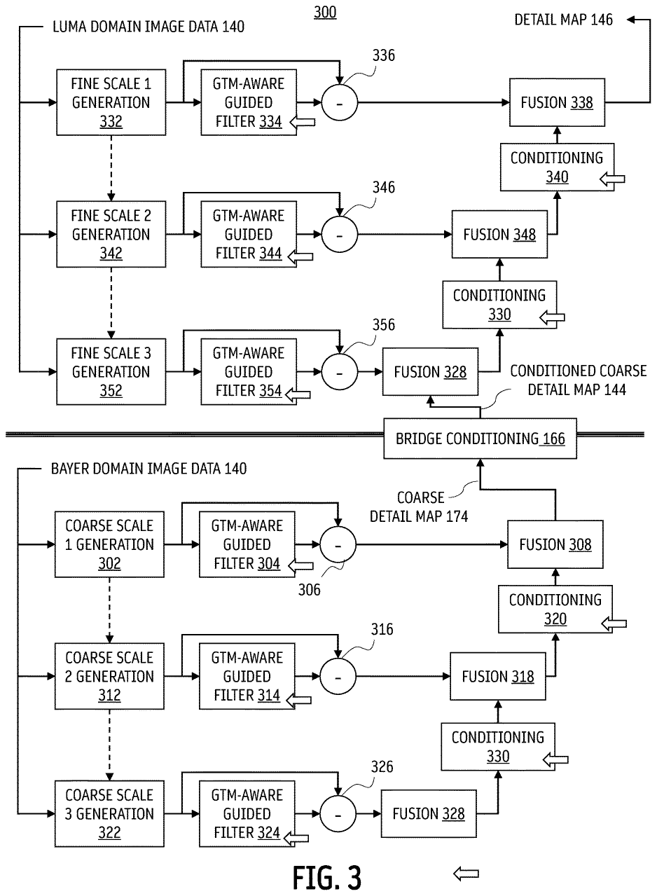

FIG. 3 illustrates multi-scale filtering structure 300 to generate a detail map, according to some examples of the disclosure. Multi-scale filtering structure 300 can be implemented using one or more portions of image processing unit 190 as illustrated in FIG. 1, such as coarse details extraction 120, bridge conditioning 166, fine details extraction and fusion 122, parameters 180, and segmentation map 182. Multi-scale filtering structure 300 illustrates an example in which multiple scale images are generated in different processing domains, edge-preserving base images are generated for respective scale images, detail layers are generated based on differences between the scale images and the edge-preserving base images, and the detail layers are fused to generate detail map 146. Although FIG. 3 illustrates three coarse scale paths and three fine scale paths, multi-scale filtering structure 300 can include one scale path, two scale paths, three scale paths, more than three scale paths, one processing domain, two processing domains, or more than two processing domains.

Multi-scale filtering structure 300 can include a coarse-domain portion and a fine-domain portion. The coarse-domain portion can receive raw-domain image data, such as Bayer domain image data 140, and can generate coarse detail map 174. The fine-domain portion can receive luma-domain image data, such as luma-domain image data 142 of FIG. 1, and can generate detail map 146 based on conditioned coarse detail map 144 and one or more fine detail layers. In some examples, the “luma domain image data 140” label shown in FIG. 3 can correspond to luma-domain image data 142 of FIG. 1. The illustrated split between Bayer domain image data 140 and luma-domain image data 142 is one example. In some examples, a coarse-domain portion can receive raw-domain image data, color-filter-array image data, monochrome sensor image data, partially processed sensor image data, downscaled sensor image data, pre-demosaic image data, post-demosaic image data, RGB-domain image data, or intermediate-domain image data. In some examples, a fine-domain portion can receive luma-domain image data, luminance-derived image data, RGB-domain image data, YUV-domain image data, grayscale image data, post-denoise image data, post-demosaic image data, or image data generated at a downstream stage of an image processing path.

Separating coarse-scale processing from fine-scale processing can provide one or more technical advantages. For example, generating coarse detail information from raw-domain or lower-resolution image data can reduce buffering, bandwidth, or line-buffer requirements in implementations where downstream image data has more components per pixel or a higher data volume. Generating fine detail information from luma-domain image data can allow fine texture, local contrast, and edge-adjacent detail to be extracted from image data that has undergone one or more upstream operations, such as denoising, demosaic, color correction, color conversion, or luma generation. Bridge conditioning 166 can connect these portions by adapting coarse detail map 174 for use in the fine-domain portion.

In the coarse-domain portion, one or more of coarse scale 1 generation 302, coarse scale 2 generation 312, and coarse scale 3 generation 322 can generate respective coarse scale images from Bayer domain image data 140. Each coarse scale image can correspond to a spatial resolution, sampling density, spatial-frequency band, or image-pyramid level. Coarse scale 1 generation 302, coarse scale 2 generation 312, and coarse scale 3 generation 322 can perform one or more of downscaling, decimation, binning, filtering, resampling, interpolation, pyramid generation, tile-based scale generation, and selecting an available scaled representation. The dashed arrows between scale generation blocks indicate that one coarse scale image can be generated from another coarse scale image in a cascaded manner. In some examples, two or more coarse scale images can be generated independently from Bayer domain image data 140.

GTM-aware guided filter 304, GTM-aware guided filter 314, and GTM-aware guided filter 324 can generate edge-preserving base images for respective coarse scale images. For a scale image Is at scale s, a corresponding GTM-aware guided filter can generate a base image Bs by computing local statistics of Is, generating one or more guided-filter coefficients from the local statistics, smoothing the guided-filter coefficients, and applying the smoothed coefficients to generate Bs. Subtraction 306, subtraction 316, and subtraction 326 can generate respective coarse detail layers based on differences between respective coarse scale images and corresponding edge-preserving base images. For example, a detail layer Ds for scale s can be generated according to:

Ds = Is − Bs

In this example, Is can represent a coarse scale image generated from Bayer domain image data 140, Bs can represent edge-preserving smooth image data generated by one of GTM-aware guided filter 304, GTM-aware guided filter 314, and GTM-aware guided filter 324, and Ds can represent detail information removed or smoothed from Is by the corresponding guided filter.

In some examples, each GTM-aware guided filter can compute local statistics over a support window. For example, a local mean us and local variance σs² can be computed for scale image Is according to:

μs = mean(Is)
σs² = mean(Is²) − μs²

The mean operations can be implemented using one or more of horizontal summation, vertical summation, separable box filtering, sliding-window accumulation, and integral-image-style accumulation. Computing local variance can allow the corresponding GTM-aware guided filter to distinguish relatively smooth regions from regions having one or more of edges, texture, contrast transitions, and structural variation.

In some examples, GTM-aware guided filter 304, GTM-aware guided filter 314, or GTM-aware guided filter 324 can normalize local variance, a variance threshold, or a filtering decision value based on a tone mapping function. For example, a normalized variance value σs,norm² can be represented generally as:

σs,norm² = NormGTM(σs², Is, GTM),

NormGTM can be a luma-dependent, tone-mapping-dependent, or calibration-dependent normalization function. In some examples, NormGTM can be implemented using a lookup table indexed by one or more of luma, scale, tone-mapping gain, tone-mapping curve segment, and a quantized image value. In a more specific example, a luma-dependent threshold Es (Is) can be used so that guided-filter behavior depends on expected tone-mapping behavior at a corresponding luminance. Tone-mapping-aware variance normalization can allow detail extraction to account for contrast compression or contrast expansion expected from global tone mapping 130.

In some examples, each GTM-aware guided filter can generate guided-filter coefficients using σs, norm², εs(Is), or both. For example, a coefficient as can be generated according to:

αs = σs,norm² / (σs,norm² + εs)

es can be a fixed threshold, a scale-dependent threshold, a luma-dependent threshold, a tone-mapping-aware threshold, or a value derived from parameters 180. Coefficient as can correspond to a detail-preserving factor that tends toward preserving input image data in higher-variance regions and tends toward smoothing input image data in lower-variance regions. A further coefficient Bs can be generated based on us and as, such as:

βs = μs · (1 − αs)

The guided-filter coefficients as and Bs can be smoothed over a further support window before generation of base image Bs. In some examples, a support window used to compute σs² can be different from a support window used to smooth as or Bs. Using different support windows can reduce total support, buffering, or latency while maintaining edge-aware smoothing behavior.

Fusion 328, conditioning 330, fusion 318, conditioning 320, and fusion 308 can combine coarse detail layers to generate coarse detail map 174. For example, fusion 328 can receive a coarse detail layer generated by subtraction 326 and can output fused coarse detail information. Conditioning 330 can condition the fused coarse detail information for combination with a further coarse detail layer generated by subtraction 316, and fusion 318 can fuse the conditioned detail information with the further coarse detail layer. Conditioning 320 can condition the output of fusion 318 for combination with a further coarse detail layer generated by subtraction 306, and fusion 308 can generate coarse detail map 174. In some examples, conditioning 330 or conditioning 320 can perform one or more of scale conversion, upscaling, interpolation, spatial alignment, phase alignment, normalization, clamping, floor application, fixed-point formatting, power weighting, and segmentation-aware weighting.

Fusion 328, fusion 318, or fusion 308 can perform one or more of summation, weighted summation, overlap-aware fusion, sign-based overlap reduction, saturation control, and coarse-to-fine accumulation. In some examples, a lower-resolution coarse detail layer can be upscaled and fused with a higher-resolution coarse detail layer. For example, a coarse detail layer from coarse scale 3 generation 322 can be fused with a detail layer from coarse scale 2 generation 312, and a resulting fused coarse detail representation can be fused with a detail layer from coarse scale 1 generation 302. This coarse-to-fine fusion can preserve coarse structure across multiple spatial scales while generating coarse detail map 174 at a scale suitable for bridge conditioning 166.

In some examples, overlap-aware fusion can be expressed for two adjacent detail values Di(p) and Dj(p) at pixel location p. When Di(p) and Dj(p) have the same sign, a fusion circuit can compute an overlap contribution ol(p) based on magnitudes of Di(p) and Dj(p). For example, the overlap contribution can be represented generally as:

ol(p) = sign(Di(p)) · Foverlap(|Di(p)|, |Dj(p)|)

Foverlap can be implemented using one or more of a square-root function, a lookup table, a multiplier, a shift operation, a scaling operation, a clipping operation, and a calibration-controlled approximation. In one implementation, Foverlap can be based on a square-root approximation of a product of scaled magnitudes of Di (p) and Dj (p). When Di (p) and Dj(p) have different signs, ol(p) can be set to zero or reduced so that cancellation between opposite-phase detail values is preserved.

In some examples, fusion 328, fusion 318, fusion 308, fusion 348, or fusion 338 can generate a fused detail value YF(p) according to:

YF(p) = Di(p) + Dj(p) − ol(p)

In this example, Di(p) can correspond to a detail layer at one scale, Dj(p) can correspond to a detail layer or conditioned fused detail value at an adjacent scale, and ol(p) can correspond to an estimated overlap contribution. Subtracting ol(p) when same-phase detail appears in adjacent scale representations can reduce redundant enhancement of the same image structure. Reducing or omitting ol(p) when adjacent detail values have different signs can preserve natural cancellation between detail layers.

Bridge conditioning 166 can receive coarse detail map 174 and output conditioned coarse detail map 144. Bridge conditioning 166 can adapt coarse detail map 174 generated from Bayer domain image data 140 for use with detail information generated from luma-domain image data 142. For example, bridge conditioning 166 can perform one or more of scale conversion, spatial alignment, domain normalization, luminance correction, parameterized weighting, clamping, floor application, fixed-point conversion, and format conversion. In some examples, bridge conditioning 166 can compensate for differences between raw-domain intensity information and luma-domain intensity information so that conditioned coarse detail map 144 can be fused with one or more fine detail layers. Bridge conditioning 166 can provide a cross-domain handoff between detail extraction performed in a raw-domain portion of a pipeline and detail extraction performed in a luma-domain portion of a pipeline.

In some examples, bridge conditioning 166 can normalize coarse detail map 174 relative to a corresponding intensity value before coarse detail map 174 is used by the fine-domain portion. For example, bridge conditioning 166 can divide one or more values of coarse detail map 174 by one or more of a raw-domain intensity value, a Bayer-derived intensity value, a downscaled luma value, a base-image value, and a luma-domain reference value. Bridge conditioning 166 can use one or more of a lookup-table-based divider, a minimum denominator, a clamp value, a fixed-point scale value, and a calibration parameter from parameters 180. Such conditioning can reduce sensitivity to absolute signal level and can prepare coarse detail map 174 for fusion with luma-domain fine detail information.

In the fine-domain portion, one or more of fine scale 1 generation 332, fine scale 2 generation 342, and fine scale 3 generation 352 can generate respective fine scale images from luma-domain image data 142. Each fine scale image can correspond to a different spatial resolution, sampling density, spatial-frequency band, or image-pyramid level. Fine scale 1 generation 332, fine scale 2 generation 342, and fine scale 3 generation 352 can perform one or more of downscaling, filtering, resampling, interpolation, pyramid generation, tile-based scale generation, full-resolution image selection, and selecting an available scaled representation. The dashed arrows between fine scale generation blocks indicate that one fine scale image can be generated from another fine scale image in a cascade. In some examples, two or more fine scale images can be generated independently from luma-domain image data 142.

GTM-aware guided filter 334, GTM-aware guided filter 344, and GTM-aware guided filter 354 can generate edge-preserving base images for respective fine scale images. Subtraction 336, subtraction 346, and subtraction 356 can generate respective fine detail layers according to Ds=Is−Bs for corresponding fine scale images. In this example, Is can represent a fine scale image generated from luma-domain image data 142, Bs can represent edge-preserving smooth image data generated by one of GTM-aware guided filter 334, GTM-aware guided filter 344, and GTM-aware guided filter 354, and Ds can represent detail information smoothed from Is by the corresponding guided filter. The fine detail layers can represent one or more of local contrast, texture, edge-adjacent structure, hair detail, foliage detail, surface texture, and high-spatial-frequency image content.

Fusion 328, conditioning 330, fusion 348, conditioning 340, and fusion 338 can combine conditioned coarse detail map 144 with fine detail layers to generate detail map 146. For example, fusion 328 can fuse conditioned coarse detail map 144 with a fine detail layer generated by subtraction 356. Conditioning 330 can condition an output of fusion 328 for fusion with a further fine detail layer generated by subtraction 346, and fusion 348 can combine the conditioned output with the further fine detail layer. Conditioning 340 can condition an output of fusion 348 for fusion with a further fine detail layer generated by subtraction 336, and fusion 338 can output detail map 146. In some examples, these fusions can proceed in a coarse-to-fine order, with lower-resolution detail information being upscaled or aligned before fusion with higher-resolution detail information.

Conditioning 330 and conditioning 340 in the fine-domain portion can perform one or more of scale conversion, upscaling, interpolation, phase alignment, spatial alignment, normalization, clamping, saturation control, fixed-point formatting, power weighting, and segmentation-aware weighting. For example, conditioning 330 can convert an output of fusion 328 to a scale, precision, or alignment suitable for fusion 348, and conditioning 340 can convert an output of fusion 348 to a scale, precision, or alignment suitable for fusion 338. The conditioning blocks illustrated in the coarse-domain portion and the fine-domain portion can be implemented by separate circuits, shared circuits, programmable processing resources, lookup tables, fixed-function arithmetic circuitry, firmware-controlled circuitry, or a shared conditioning pipeline.

GTM-aware guided filter 304, GTM-aware guided filter 314, GTM-aware guided filter 324, GTM-aware guided filter 334, GTM-aware guided filter 344, and GTM-aware guided filter 354 can use the same guided-filter architecture or different guided-filter architectures. In some examples, at least two GTM-aware guided filters can use different guided-filter parameters. The different guided-filter parameters can include one or more of support-window size, coefficient-smoothing-window size, threshold curve, variance-normalization parameter, detail-power parameter, bit precision, clamp value, smoothing strength, and scale factor. Using different guided-filter parameters at different scales can allow multi-scale filtering structure 300 to tune coarse shape restoration, mid-scale structure restoration, and fine texture restoration independently.

In some examples, one or more of GTM-aware guided filter 334, GTM-aware guided filter 344, GTM-aware guided filter 354, fusion 328, fusion 348, fusion 338, conditioning 330, and conditioning 340 in the fine-domain portion can be implemented in a manner similar to corresponding guided filters, fusion blocks, and conditioning blocks in the coarse-domain portion. For example, a fine-domain guided filter can compute local statistics, apply tone-mapping-aware variance normalization, generate guided-filter coefficients, smooth the guided-filter coefficients, and generate an edge-preserving base image using operations similar to those described for GTM-aware guided filter 304, GTM-aware guided filter 314, or GTM-aware guided filter 324. A fine-domain fusion block can perform summation, weighted summation, overlap-aware fusion, sign-based overlap reduction, saturation control, or coarse-to-fine accumulation using operations similar to those described for fusion 328, fusion 318, or fusion 308. A fine-domain conditioning block can perform scale conversion, upscaling, interpolation, spatial alignment, phase alignment, normalization, clamping, floor application, fixed-point formatting, power weighting, or segmentation-aware weighting using operations similar to those described for conditioning 330 or conditioning 320 in the coarse-domain portion.

In some examples, multi-scale filtering structure 300 can apply scale-specific powers to one or more detail layers before, during, or after fusion. A scale-specific power can be applied to a coarse detail layer, conditioned coarse detail map 144, a fine detail layer, an intermediate fused detail map, or detail map 146. A scale-specific power can be received from parameters 180, derived from segmentation map 182, derived from local image statistics, derived from luma-domain image data 142, derived from Bayer domain image data 140, or based on a tone mapping function. Scale-specific powers can allow enhancement strength to be controlled separately for large-scale structure, mid-scale structure, and fine texture. For example, fine texture enhancement can be increased for foliage while high-frequency enhancement can be reduced for skin.

In some examples, multi-scale filtering structure 300 can apply saturation control to one or more of detail layer Ds, overlap contribution ol(p), fused detail value YF(p), coarse detail map 174, conditioned coarse detail map 144, and detail map 146. Saturation control can include a piecewise function GS(x) applied to a detail value x. For example, GS(x) can pass x substantially linearly in a first magnitude range, compress x in a transition magnitude range, and limit x in a saturation magnitude range. Applying gradual saturation can reduce discontinuities associated with hard clipping when detail values exceed a selected bit precision, while preserving detail fidelity for values within a normal operating range.

The parameterizable arrows shown in FIG. 3 indicate that one or more blocks of multi-scale filtering structure 300 can be controlled by parameters 180, segmentation map 182, image statistics, tone-mapping information, calibration values, firmware settings, or a combination thereof. For example, parameters can be supplied to one or more of GTM-aware guided filter 304, GTM-aware guided filter 314, GTM-aware guided filter 324, GTM-aware guided filter 334, GTM-aware guided filter 344, GTM-aware guided filter 354, conditioning 330, conditioning 320, conditioning 340, fusion 328, fusion 318, fusion 308, fusion 348, and fusion 338. Parameterizable values can include one or more of scale-selection parameters, support-window sizes, coefficient-smoothing-window sizes, tone-mapping-aware variance-normalization values, threshold curves, detail powers, segmentation-based weights, overlap-reduction coefficients, saturation limits, clamp values, floor values, interpolation parameters, luma-correction values, and fixed-point scaling values. Parameterization can allow multi-scale filtering structure 300 to be tuned for different sensors, resolutions, tone-mapping curves, imaging modes, scene content, and hardware budgets without changing the illustrated high-level architecture.

Although FIG. 3 illustrates a cascaded fusion structure, multi-scale filtering structure 300 can be implemented using a different fusion arrangement. For example, detail layers can be fused using one or more of pairwise fusion, tree-based fusion, weighted summation, parallel fusion followed by normalization, coarse-to-fine fusion, fine-to-coarse fusion, and iterative fusion. In some examples, bridge conditioning 166 can be omitted when detail layers are generated in a common domain. In some examples, bridge conditioning 166 can be repeated between more than two domains. In some examples, one or more of the coarse-domain portion and the fine-domain portion can be omitted, bypassed, or replaced with a different scale group. Such variations can allow multi-scale filtering structure 300 to support multiple image processing pipelines while preserving a common operation of generating scale images, generating edge-preserving base images, generating detail layers, and fusing the detail layers to generate detail map 146.

### Example Tone-Mapping-Aware Guided Filtering Process

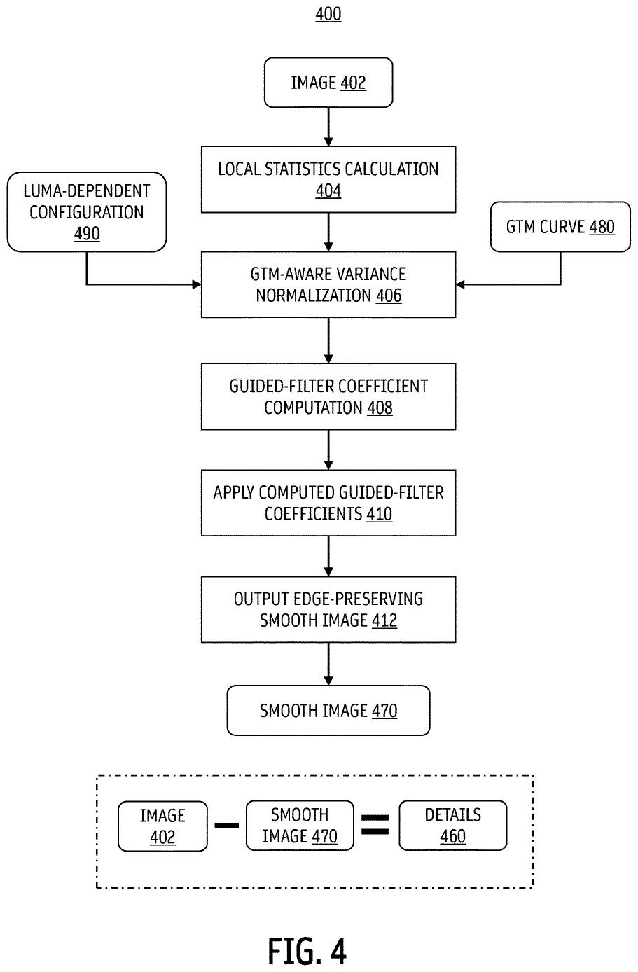

FIG. 4 is a flowchart illustrating method 400 for performing global tone mapping aware guided filtering to generate edge-preserving smooth image data, according to some examples of the disclosure. Method 400 can be performed by one or more GTM-aware guided filters described with reference to FIG. 3, such as GTM-aware guided filter 304, GTM-aware guided filter 314, GTM-aware guided filter 324, GTM-aware guided filter 334, GTM-aware guided filter 344, and GTM-aware guided filter 354. Method 400 can be performed for a coarse scale image, a fine scale image, raw-domain image data, Bayer domain image data 140, luma-domain image data 142, or another image 402 used for detail extraction. Method 400 can generate smooth image 470, which can be an edge-preserving base image used to generate details 460 based on a difference between image 402 and smooth image 470.

In method 400, a guided filter circuit can receive image 402. Image 402 can be a scale image generated by a scale generation circuit, such as one of coarse scale 1 generation 302, coarse scale 2 generation 312, coarse scale 3 generation 322, fine scale 1 generation 332, fine scale 2 generation 342, and fine scale 3 generation 352. Method 400 can include receiving a raw-domain scale image, a Bayer-domain scale image, a luma-domain scale image, an RGB-domain scale image, a luminance-derived scale image, or an image generated at another stage of an image processing path. In some examples, image 402 can be used as both an input image and a guide image for guided filtering. In some examples, image 402 can be filtered using a different guide image generated from image 402 or from a related image representation.

In 404, the guided filter circuit can perform local statistics calculation for image 402. Performing local statistics calculation in 404 can include computing one or more of a local mean, a local mean of squared image values, a local variance, a local covariance, a local intensity value, and a local luma value for pixels or pixel groups of image 402. For example, for a scale image I, local statistics calculation in 404 can compute a local mean u and local variance 62 according to μ=mean(I) and σ²=mean(I²)−μ². In some examples, mean operations can be implemented using one or more of horizontal summation, vertical summation, separable filtering, sliding-window accumulation, and line-buffer-based accumulation. Local statistics calculation in 404 can therefore provide local image information used to determine whether a region is relatively smooth or contains structure, texture, edge content, or contrast variation.

In 406, the guided filter circuit can perform GTM-aware variance normalization based on one or more of local statistics from 404, GTM curve 480, and luma-dependent configuration 490. Performing GTM-aware variance normalization in 406 can include normalizing one or more of local variance, a variance threshold, a filtering decision value, a guided-filter coefficient, and a detail-preservation parameter based on a tone mapping function. GTM curve 480 can represent a global tone mapping curve, a tone mapping gain, a tone mapping slope, a tone mapping segment, or a parameter derived from global tone mapping 130. Luma-dependent configuration 490 can represent one or more calibration values, lookup tables, threshold curves, normalization curves, or luma-indexed parameters. In some examples, a normalized variance σnorm² can be represented generally as σnorm²=NormGTM(σ², I, GTM), where NormGTM is a luma-dependent, tone-mapping-dependent, or calibration-dependent normalization function.

GTM-aware variance normalization in 406 can allow method 400 to account for image-dependent effects of later tone mapping when generating smooth image 470. For example, a fixed variance threshold can treat image details similarly across luminance regions even though GTM curve 480 may compress contrast in some regions and expand contrast in other regions. By using GTM curve 480, luma-dependent configuration 490, or both, method 400 can adjust guided-filter behavior according to expected tone-mapping behavior. In some examples, GTM-aware variance normalization in 406 can use a luma-dependent threshold ε(I), a scale-dependent threshold, a tone-mapping-aware threshold, or a threshold curve stored in parameters 180. This can support stronger preservation of details expected to be compressed by global tone mapping 130 and controlled enhancement of details expected to be amplified by global tone mapping 130.

In 408, the guided filter circuit can perform guided-filter coefficient computation. Performing guided-filter coefficient computation in 408 can include computing one or more guided-filter coefficients based on local statistics from 404 and normalized values from GTM-aware variance normalization in 406. For example, coefficient α can be generated according to α=σnorm²/(σnorm²+ε), where ε can be one or more of a fixed threshold, a luma-dependent threshold, a tone-mapping-aware threshold, a scale-dependent threshold, and a calibration-controlled value. A further coefficient β can be generated based on local mean μ and coefficient α, such as β=μ·(1−α). In some examples, coefficient α can operate as a detail-preserving factor that tends to preserve image 402 in high-variance regions and tends to smooth image 402 in low-variance regions.

In 410, the guided filter circuit can apply computed guided-filter coefficients. Performing 410 can include smoothing one or more computed guided-filter coefficients, applying smoothed coefficients to image 402, and generating edge-preserving smooth image data. In some examples, the guided filter circuit can smooth coefficient α, coefficient β, or values derived from coefficient α and coefficient β over a coefficient-smoothing support window. The support window used for local statistics calculation in 404 can be the same as, or different from, the coefficient-smoothing support window used in 410. Using different support windows can reduce total filter support, line-buffer usage, latency, or circuit area for a selected image-quality target.

In 412, the guided filter circuit can output edge-preserving smooth image data as smooth image 470. Performing 412 can include generating smooth image 470 by applying the computed guided-filter coefficients to image 402. For example, smooth image 470 can be generated as an edge-preserving base image B based on one or more smoothed coefficients and image 402. Smooth image 470 can preserve one or more edges, high-contrast transitions, or structural features while smoothing one or more low-contrast details, textures, or local variations. Smooth image 470 can therefore provide a base image for extracting detail information from image 402.

In some examples, details 460 can be generated based on image 402 and smooth image 470. For example, details 460 can be generated according to Details=image 402—smooth image 470. Details 460 can represent image content present in image 402 but smoothed by method 400 when generating smooth image 470. Details 460 can correspond to a coarse detail layer when image 402 is a coarse scale image, and details 460 can correspond to a fine detail layer when image 402 is a fine scale image. Details 460 can be provided to one or more fusion blocks described with reference to FIG. 3 to generate coarse detail map 174, conditioned coarse detail map 144, detail map 146, or an intermediate fused detail map.

Method 400 can be parameterized differently for different scales, domains, image regions, or processing modes. For example, different instances of method 400 can use different support-window sizes, coefficient-smoothing-window sizes, threshold curves, GTM-aware variance-normalization parameters, luma-dependent configurations, bit precisions, clamp values, scale factors, or detail-power parameters. Parameterizing method 400 per scale can allow coarse detail layers and fine detail layers to be extracted using different filtering behavior. Parameterizing method 400 based on GTM curve 480, luma-dependent configuration 490, segmentation map 182, or parameters 180 can allow edge-preserving smooth image data to be generated in a manner that accounts for tone mapping, semantic content, local brightness, calibration preferences, and hardware constraints.

In some examples, method 400 can use local variance differently from a denoising guided filter. In a denoising application, a variance threshold may be selected to distinguish noise from image structure. In method 400, the variance threshold can instead be selected to distinguish detail information to be extracted and later restored from image structure that should be preserved in smooth image 470. For example, a threshold used by GTM-aware variance normalization in 406 can correspond to a contrast level of detail that image processing unit 190 is configured to restore after global tone mapping 130. As a result, a low-contrast texture or local contrast variation can be smoothed into details 460, while stronger edges or structures can remain at least partially preserved in smooth image 470.

In some examples, GTM-aware variance normalization in 406 can use a tunable threshold curve rather than a fixed threshold expression associated with a guided-filter reference implementation. The tunable threshold curve can be represented by luma-dependent configuration 490, parameters 180, a lookup table, a piecewise-linear function, a programmable curve, or a calibration-controlled function. In some examples, the tunable threshold curve can be selected independently for different scale images, different image domains, different tone-mapping curves, or different imaging modes. Providing a tunable threshold curve can allow method 400 to adapt guided-filter behavior for detail restoration, rather than limiting method 400 to a threshold behavior selected for denoising.

In some examples, GTM-aware variance normalization in 406 can adjust a variance value before a guided-filter decision is made because the corresponding detail information will later be affected by global tone mapping 130. For example, local statistics calculation in 404 can compute a local variance for image 402 before global tone mapping 130 is applied, while global tone mapping 130 can later modify the apparent magnitude of that variance in tone mapped image 148. GTM-aware variance normalization in 406 can therefore scale, normalize, or bias one or more of the local variance, a variance threshold, and a filtering decision value based on GTM curve 480. This allows method 400 to make an earlier guided-filter decision using information about a later tone-mapping operation.

In some examples, GTM-aware variance normalization in 406 can use a GTM-related gain factor derived from GTM curve 480. For example, local variance can be normalized based on one or more of a tone-mapping gain, a tone-mapping slope, a luma-dependent gain value, and a value derived from a tone-mapping curve segment. In some implementations, a variance adjustment based on a squared tone-mapping gain can be approximated or replaced by an adjustment based on the tone-mapping gain itself. Such an implementation can reduce over-correction, reduce hardware complexity, or provide a calibration result that is preferred for a selected image-quality target.

In some examples, luma-dependent configuration 490 can provide calibration freedom separate from GTM curve 480. For example, GTM curve 480 can represent how global tone mapping 130 is expected to compress or expand image contrast, while luma-dependent configuration 490 can represent how strongly method 400 should preserve, smooth, or extract detail at different luma levels. GTM-aware variance normalization in 406 can combine GTM curve 480 with luma-dependent configuration 490 so that a guided-filter decision depends on both expected tone-mapping behavior and a calibrator-selected detail-restoration preference.

In some examples, GTM curve 480 can provide tone-mapping information used by GTM-aware variance normalization in 406. GTM curve 480 can include one or more of an input-to-output tone mapping curve, a tone-mapping gain curve, a slope of a tone-mapping curve, a local derivative of a tone-mapping curve, a compression ratio, an expansion ratio, a curve segment identifier, a piecewise-linear curve parameter, and a lookup table representing a tone-mapping function. GTM-aware variance normalization in 406 can use GTM curve 480 to determine how a local contrast value, variance value, or detail value in image 402 is expected to be changed by global tone mapping 130. For example, if GTM curve 480 indicates that a particular luma range will be compressed, GTM-aware variance normalization in 406 can adjust a variance threshold or variance normalization value so that details in that luma range are more likely to be extracted into details 460 before tone mapping.

In some examples, luma-dependent configuration 490 can provide calibration information used by GTM-aware variance normalization in 406. Luma-dependent configuration 490 can include one or more of a luma-indexed lookup table, a threshold curve, a variance-normalization curve, a detail-preservation curve, a scale-dependent calibration table, a scene-mode-dependent calibration table, a sensor-specific calibration table, and a user-mode-dependent tuning curve. Luma-dependent configuration 490 can be indexed by one or more of image 402, a local mean value, a local luma value, a base-image value, a scale identifier, a domain identifier, and a tone-mapping segment identifier. Luma-dependent configuration 490 can allow a calibrator to select how aggressively method 400 extracts details at different luma levels, independently of the mathematical shape of GTM curve 480.

In some examples, GTM-aware variance normalization in 406 can use GTM curve 480 without luma-dependent configuration 490, can use luma-dependent configuration 490 without GTM curve 480, or can use GTM curve 480 together with luma-dependent configuration 490. For example, GTM-aware variance normalization in 406 can compute a GTM-related value from GTM curve 480 and then modify that GTM-related value using a calibration value from luma-dependent configuration 490. In another example, GTM-aware variance normalization in 406 can use luma-dependent configuration 490 to select among multiple normalization curves derived from GTM curve 480. In another example, GTM-aware variance normalization in 406 can bypass GTM curve 480 and use luma-dependent configuration 490 as a programmed approximation of tone-mapping-aware behavior.

In some examples, GTM-aware variance normalization in 406 can generate a normalization parameter N based on GTM curve 480, luma-dependent configuration 490, or both. For example, N can be generated according to:

N = f(GTM(luma), CU(luma))

GTM (luma) represents a value derived from GTM curve 480, CU (luma) represents a value derived from luma-dependent configuration 490, and f represents a combination function. The combination function can include one or more of multiplication, addition, interpolation, weighted blending, minimum selection, maximum selection, clamping, piecewise selection, and table lookup. The normalization parameter N can be used to scale a local variance value, scale a variance threshold, select a threshold curve, modify a filtering decision value, or modify a guided-filter coefficient.

In some examples, GTM-aware variance normalization in 406 can apply normalization parameter N to a local variance value. For example, for local variance σ², GTM-aware variance normalization in 406 can generate a normalized variance σnorm² according to:

σnorm² = σ² · N

In another example, GTM-aware variance normalization in 406 can apply normalization parameter N to a variance threshold & according to:

εnorm = ε · N

In another example, GTM-aware variance normalization in 406 can apply N to both σ² and ε, or can select between variance normalization and threshold normalization based on a scale identifier, domain identifier, or parameter value. Expressing tone-mapping awareness as normalization of one or more of local variance and a variance threshold can support multiple hardware implementations while preserving the same functional purpose.

In some examples, GTM-aware variance normalization in 406 can be implemented using lookup tables instead of real-time curve computation. For example, parameters 180 can store a first lookup table derived from GTM curve 480, a second lookup table corresponding to luma-dependent configuration 490, and a third lookup table representing a combined normalization value. GTM-aware variance normalization in 406 can index one or more lookup tables using a quantized luma value, local mean value, scale identifier, domain identifier, or tone-mapping segment identifier. Lookup-table implementation can reduce arithmetic cost and can allow normalization behavior to be updated by changing parameters 180 without changing the guided-filter datapath.

In some examples, GTM curve 480 and luma-dependent configuration 490 can be parameterized per scale. For example, a coarse scale path can use a first GTM-aware variance-normalization table, a first threshold curve, or a first luma-dependent configuration, while a fine scale path can use a second GTM-aware variance-normalization table, a second threshold curve, or a second luma-dependent configuration. Per-scale parameterization can allow method 400 to preserve large-scale contrast differently from fine texture. For example, a coarse scale path can use normalization values selected to avoid halo-like over-enhancement of low-spatial-frequency structure, while a fine scale path can use normalization values selected to preserve subtle texture that may be compressed by global tone mapping 130.

In some examples, GTM curve 480 and luma-dependent configuration 490 can be parameterized per image domain or per processing mode. For example, raw-domain guided filtering can use normalization values based on a raw-domain luma approximation or Bayer-derived intensity value, while luma-domain guided filtering can use normalization values based on luma-domain image data 142. In some examples, different configurations can be selected for still capture, video capture, high-dynamic-range capture, low-light capture, high-frame-rate capture, power-saving mode, or a sensor operating mode. Selecting different configurations can allow method 400 to account for differences in noise level, dynamic range, tone-mapping strength, and available processing resources.

In some examples, luma-dependent configuration 490 can be combined with segmentation-aware or content-aware control. For example, luma-dependent configuration 490 can provide a baseline normalization curve for a luma range, and segmentation map 182 can provide a content-dependent modifier for that luma range. A skin region, a foliage region, a sky region, a text region, or a light-source region can therefore use different normalization behavior even when the regions have similar luma values. Combining GTM curve 480, luma-dependent configuration 490, and content-dependent control can allow method 400 to account for both downstream tone mapping and content-specific detail-restoration preferences.

### Example Bridge Conditioning Process

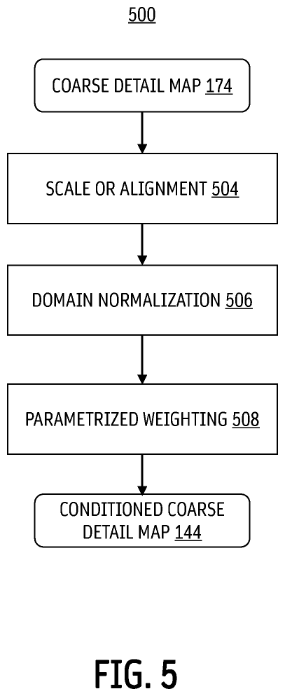

FIG. 5 is a flowchart illustrating method 500 for bridge conditioning, according to some examples of the disclosure. Method 500 can be performed by bridge conditioning 166 of image processing unit 190 as illustrated in FIGS. 1 and 3. Method 500 can receive coarse detail map 174 generated from one or more coarse detail layers and can output conditioned coarse detail map 144 for use by fine details extraction and fusion 122. In some examples, method 500 can adapt coarse detail map 174 generated in a raw-domain portion of image processing unit 190 for fusion with one or more fine detail layers generated in a luma-domain portion of image processing unit 190. Although FIG. 5 illustrates scale or alignment in 504, domain normalization in 506, and parameterized weighting in 508 in sequence, one or more of these operations can be performed in a different order, repeated, combined, omitted, bypassed, or performed by shared circuitry.

In 504, bridge conditioning 166 can perform scale or alignment processing on coarse detail map 174. Performing scale or alignment in 504 can include one or more of upscaling, downscaling, interpolation, decimation, resampling, phase alignment, spatial alignment, crop adjustment, tile alignment, coordinate remapping, delay alignment, and format alignment. In some examples, bridge conditioning 166 can convert coarse detail map 174 from a resolution associated with coarse details extraction 120 to a resolution associated with a fine scale image processed by fine details extraction and fusion 122. For example, bridge conditioning 166 can upscale coarse detail map 174 from a ⅛-scale representation to a ¼-scale representation before coarse detail information is fused with a ¼-scale fine detail layer. Scale or alignment in 504 can allow coarse detail information generated at an earlier scale or pipeline stage to be spatially registered with downstream luma-domain detail information.

In 506, bridge conditioning 166 can perform domain normalization on the scale-adjusted or aligned coarse detail information. Performing domain normalization in 506 can include one or more of luminance correction, intensity normalization, ratio generation, gain correction, raw-to-luma matching, Bayer-to-luma matching, offset correction, clamp application, floor application, fixed-point conversion, and lookup-table-based division. In some examples, coarse detail map 174 can be generated from raw-domain image data, while fine details extraction and fusion 122 can operate on luma-domain image data 142 generated after one or more of: demosaic, color correction, color conversion, and luma generation. Domain normalization in 506 can therefore compensate for differences between a raw-domain intensity representation used to generate coarse detail map 174 and a luma-domain representation used to generate fine detail layers.

In some examples, domain normalization in 506 can include Y correction. For example, bridge conditioning 166 can divide one or more values of coarse detail map 174 by one or more corresponding values derived from a downscaled luma image, a Bayer-derived intensity image, a raw-domain luma approximation, a base image, or a luma-domain reference image. A divider used for Y correction can be implemented using one or more of a lookup table, reciprocal approximation, multiplier, shift operation, clamp value, minimum denominator, and fixed-point scaling parameter. Y correction can reduce sensitivity of coarse detail map 174 to absolute signal level and can help condition raw-domain coarse detail information for fusion with luma-domain fine detail information.

In 508, bridge conditioning 166 can perform parameterized weighting on normalized coarse detail information. Performing parameterized weighting in 508 can include applying one or more gain values, power values, scale-dependent weights, domain-dependent weights, luma-dependent weights, tone-mapping-dependent weights, segmentation-dependent weights, radial weights, spatial gain values, calibration values, or bypass values. In some examples, parameterized weighting in 508 can use parameters 180, segmentation map 182, local image statistics, a tone mapping function, a scale identifier, a domain identifier, or an imaging mode. For example, bridge conditioning 166 can apply a coarse-detail power that controls how strongly conditioned coarse detail map 144 contributes to detail map 146. Parameterized weighting in 508 can allow coarse shape or low-spatial-frequency detail restoration to be tuned independently from fine texture restoration.

In some examples, parameterized weighting in 508 can be content-dependent. For example, bridge conditioning 166 can use segmentation map 182 to generate a power map applied to coarse detail map 174 before conditioned coarse detail map 144 is fused with one or more fine detail layers. A face or skin region can receive a coarse-detail weight selected to preserve three-dimensional shape while avoiding excessive high-frequency enhancement in later stages. A foliage, hair, fabric, or textured region can receive a different coarse-detail weight selected to preserve structure. A sky, wall, flat-region, or low-texture region can receive a lower coarse-detail weight to reduce visible noise or banding. Content-dependent parameterized weighting can adapt coarse-detail contribution while preserving the common bridge conditioning flow.

Bridge conditioning 166 can output conditioned coarse detail map 144 after performing one or more of scale or alignment in 504, domain normalization in 506, and parameterized weighting in 508. Conditioned coarse detail map 144 can include coarse detail information that has been rescaled, aligned, normalized, weighted, formatted, or calibrated for use by a downstream fusion stage. In some examples, conditioned coarse detail map 144 can be fused with a fine detail layer generated from luma-domain image data 142, can be provided to a conditioning block of multi-scale filtering structure 300, or can be used to generate detail map 146. Generating conditioned coarse detail map 144 can allow image processing unit 190 to combine detail information extracted in different domains, at different scales, or at different positions in an image processing path.

In some examples, method 500 can be used to condition detail information exchanged between any two portions of an image processing pipeline. For example, method 500 can condition raw-domain detail information for luma-domain fusion, RGB-domain detail information for luma-domain fusion, luma-domain detail information for color-domain reinjection, coarse-scale detail information for fine-scale fusion, or detail information generated at a first pipeline stage for use at a second pipeline stage. Thus, bridge conditioning 166 need not be limited to Bayer-to-luma conversion and can be used whenever detail information is generated in one scale, domain, format, timing relationship, or numerical representation and is used in another scale, domain, format, timing relationship, or numerical representation.

### Example Image Processing Process

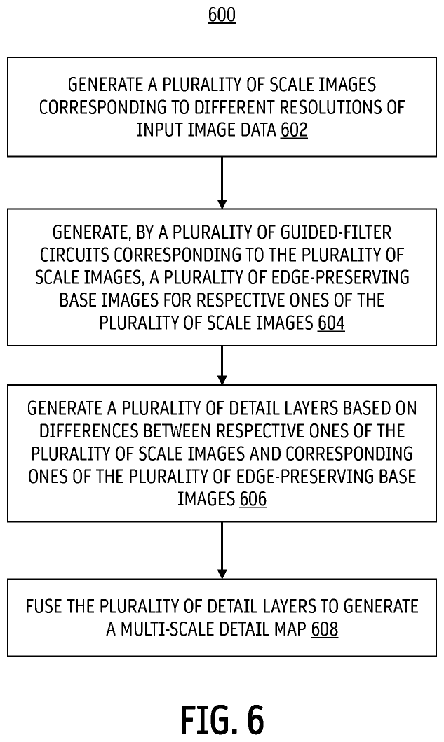

FIG. 6 is a flowchart illustrating method 600 for image processing, according to some examples of the disclosure. Method 600 can be performed by imaging system 100, image processing unit 190, multi-scale filtering structure 300, one or more guided filter circuits, one or more fusion circuits, one or more processors, one or more hardware accelerators, firmware-controlled circuitry, programmable circuitry, fixed-function circuitry, or a combination thereof. In some examples, method 600 can be used to generate detail map 146, coarse detail map 174, conditioned coarse detail map 144, a fine-detail map, an intermediate fused detail map, or restored image data 168. Although FIG. 6 illustrates operations 602, 604, 606, and 608 in sequence, one or more operations of method 600 can be performed in a different order, performed at least partially in parallel, repeated for different image scales, repeated for different image domains, or combined with one or more additional image processing operations.

In 602, image processing unit 190 can generate a plurality of scale images corresponding to different resolutions of input image data. Performing 602 can include generating scale images by one or more of downscaling, upscaling, filtering, decimating, resampling, interpolating, binning, selecting a full-resolution image, selecting a preexisting scaled image, and generating an image pyramid. In some examples, the plurality of scale images can include one or more raw-domain scale images and one or more luma-domain scale images. For example, the plurality of scale images can include one or more coarse scale images generated from Bayer domain image data 140 and one or more fine scale images generated from luma-domain image data 142. In some examples, the plurality of scale images can include at least three scale images having different resolutions, including at least one raw-domain scale image and at least one luma-domain scale image.

In some examples of 602, the raw-domain scale images can include one or more coarse scale images, and the luma-domain scale images can include one or more fine scale images. For example, coarse scale 1 generation 302, coarse scale 2 generation 312, and coarse scale 3 generation 322 can generate coarse scale images from Bayer domain image data 140, while fine scale 1 generation 332, fine scale 2 generation 342, and fine scale 3 generation 352 can generate fine scale images from luma-domain image data 142. In one implementation, the coarse scale images can include a 1/16-scale image and a ⅛-scale image, and the fine scale images can include a ¼-scale luma image, a ½-scale luma image, and a full-resolution luma image. These scale values are examples, and method 600 can use a different number of scales, different scale ratios, non-power-of-two scale ratios, tile-dependent scales, or sensor-binning-based scales.

In 604, a plurality of guided-filter circuits corresponding to the plurality of scale images can generate a plurality of edge-preserving base images for respective ones of the plurality of scale images. Performing 604 can include applying a guided-filter circuit to each of two or more scale images so that each guided-filter circuit generates an edge-preserving base image for a corresponding scale image. For example, GTM-aware guided filter 304, GTM-aware guided filter 314, GTM-aware guided filter 324, GTM-aware guided filter 334, GTM-aware guided filter 344, and GTM-aware guided filter 354 can generate edge-preserving base images for corresponding scale images. In some examples, generating the plurality of edge-preserving base images can include computing local statistics, computing local variance over a support window, normalizing one or more of local variance and a variance threshold based on a tone mapping function, computing guided-filter coefficients, smoothing the guided-filter coefficients over a further support window, and applying the smoothed guided-filter coefficients to generate an edge-preserving base image.

In some examples of 604, at least two guided-filter circuits can apply different guided-filter parameters for at least two different resolutions of the plurality of scale images. The different guided-filter parameters can include one or more of a support-window size, a coefficient-smoothing-window size, a threshold curve, a variance-normalization parameter, and a detail-power parameter. For example, a guided-filter circuit corresponding to a coarse scale image can use a first support-window size, first coefficient-smoothing-window size, first threshold curve, first variance-normalization parameter, or first detail-power parameter, while a guided-filter circuit corresponding to a fine scale image can use a second support-window size, second coefficient-smoothing-window size, second threshold curve, second variance-normalization parameter, or second detail-power parameter. Using different guided-filter parameters can allow method 600 to tune coarse spatial-frequency detail, mid-scale structure, and fine texture independently.

In 606, image processing unit 190 can generate a plurality of detail layers based on differences between respective ones of the plurality of scale images and corresponding ones of the plurality of edge-preserving base images. Performing 606 can include subtracting each edge-preserving base image from its corresponding scale image to generate a corresponding detail layer. In some examples, generating the plurality of detail layers can include generating one or more coarse detail layers from one or more raw-domain scale images and generating one or more fine detail layers from one or more luma-domain scale images. For example, subtraction 306, subtraction 316, and subtraction 326 can generate coarse detail layers from raw-domain scale images, while subtraction 336, subtraction 346, and subtraction 356 can generate fine detail layers from luma-domain scale images. A detail layer can represent one or more of local contrast, texture, edge-adjacent structure, illumination-related structure, object shape, surface shading, and spatial-frequency content that is present in a scale image and smoothed in a corresponding edge-preserving base image.

In some examples, method 600 can condition one or more coarse detail layers before fusing the one or more coarse detail layers with one or more fine detail layers. Performing the conditioning can include applying one or more of scale conversion, spatial alignment, domain normalization, luminance correction, and parameterized weighting. For example, bridge conditioning 166 can condition coarse detail map 174 to generate conditioned coarse detail map 144 before conditioned coarse detail map 144 is fused with one or more fine detail layers. Conditioning can adapt detail information generated in a raw-domain scale, data format, timing relationship, or numerical representation for use with detail information generated in a luma-domain scale, data format, timing relationship, or numerical representation.

In 608, image processing unit 190 can fuse the plurality of detail layers to generate a multi-scale detail map. Performing 608 can include fusing detail layers generated at different resolutions, different spatial-frequency ranges, different processing domains, or different stages of an image processing path. In some examples, fusing the plurality of detail layers can include upscaling a lower-resolution detail layer and fusing the upscaled lower-resolution detail layer with a higher-resolution detail layer. In some examples, the plurality of detail layers can be fused in a coarse-to-fine order. For example, a coarse detail layer can be fused with a finer luma-domain detail layer, and the fused result can be upscaled, conditioned, and fused with a further finer luma-domain detail layer. Fusing detail layers in this manner can generate detail map 146 as a multi-scale detail map representing detail information from multiple resolutions.

In some examples of 608, fusing the plurality of detail layers can include reducing an overlap contribution between adjacent detail layers among the plurality of detail layers. For example, fusion 328, fusion 318, fusion 308, fusion 348, or fusion 338 can determine whether adjacent detail layers have the same sign at a pixel location. When adjacent detail layers have the same sign at the pixel location, a fusion circuit can reduce an overlap contribution associated with the adjacent detail layers before generating a fused detail value. When adjacent detail layers have different signs at the pixel location, the fusion circuit can reduce overlap subtraction, omit overlap subtraction, or allow cancellation between the adjacent detail layers. Reducing overlap contribution can reduce redundant enhancement of detail content represented in multiple scale bands while preserving multi-scale image structure.

In some examples, method 600 can further include generating restored image data based on the multi-scale detail map and tone-mapped image data. For example, details reinjection 132 can generate a detail factor based on detail map 146 and can apply the detail factor to tone mapped image 148 to generate restored image data 168. In some examples, generating restored image data can include one or more of generating a base image based on luma-domain image data 142 and detail map 146, normalizing detail map 146 based on the base image, applying a floor value, applying a clamp value, applying a luma normalization function, generating a detail factor, multiplying one or more color components of tone mapped image 148 by the detail factor, and scaling a fixed-point result. Generating restored image data based on the multi-scale detail map can allow detail information extracted before tone mapping to be restored after tone mapping.

### Example Computing Device

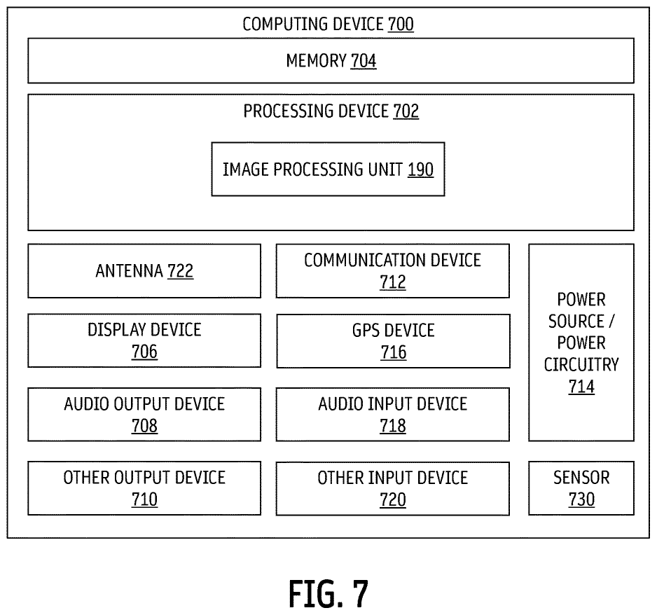

FIG. 7 is a block diagram of an apparatus or a system, e.g., an example computing device 700, according to some examples of the disclosure. One or more computing devices 700 may be used to implement the functionalities described with the FIGS. and herein. A number of components illustrated in FIG. 7 can be included in the computing device 700, but any one or more of these components may be omitted or duplicated, as suitable for the application. In some examples, some or all of the components included in the computing device 700 may be attached to one or more motherboards. In some examples, some or all of these components are fabricated onto a single system on a chip (SoC) die. Additionally, in various examples, the computing device 700 may not include one or more of the components illustrated in FIG. 7, and the computing device 700 may include interface circuitry for coupling to the one or more components. For example, the computing device 700 may not include a display device 706, and may include display device interface circuitry (e.g., a connector and driver circuitry) to which a display device 706 may be coupled. In another set of examples, the computing device 700 may not include an audio input device 718 or an audio output device 708 and may include audio input or output device interface circuitry (e.g., connectors and supporting circuitry) to which audio input device 718 or audio output device 708 may be coupled.

Computing device 700 may include processing device 702 (e.g., one or more processing devices, one or more of the same type of processing device, one or more of different types of processing devices). Processing device 702 may include electronic circuitry that processes electronic data from data storage elements (e.g., registers, memory, resistors, capacitors, quantum bit cells) to transform that electronic data into other electronic data that may be stored in registers and/or memory. Examples of processing device 702 may include a central processing unit (CPU), a graphics processing unit (GPU), an image processing unit, an image signal processor, a quantum processor, a machine learning processor, an artificial intelligence processor, a neural network processor, an artificial intelligence accelerator, an application specific integrated circuit (ASIC), an analog signal processor, an analog computer, a microprocessor, a digital signal processor, a field programmable gate array (FPGA), a tensor processing unit (TPU), a neural network hardware accelerator, a deep neural network hardware accelerator, etc.

In some examples, processing device 702 can include or be image processing unit 190, as described with reference to FIG. 1. Processing device 702 may implement one or more hardware, logic, firmware, or software components corresponding to image processing unit 190. In some examples, image processing unit 190 is a dedicated image signal processor, image processing unit, application-specific integrated circuit, or system-on-chip component to execute image processing operations. In other examples, image processing unit 190 may be implemented as one or more functional or logic blocks executed on processing device 702. Accordingly, references to operations performed by image processing unit 190 may correspond to operations performed by processing device 702, whether implemented as dedicated hardware, programmable logic, firmware, or instructions executed by processing device 702. In some examples, image processing unit 190 can be implemented as a standalone integrated circuit to perform one or more functions described herein. In some examples, image processing unit 190 can be integrated as a functional or circuit block within an SoC and as part of processing device 702, sharing resources such as memory, interconnect, and control logic with other processing components.

In some examples, memory 704 includes one or more non-transitory computer-readable media storing instructions executable to perform operations described with the FIGS. and herein. Memory 704 may include one or more non-transitory computer-readable media storing instructions executable to perform one or more operations described herein. Example parts, e.g., parts illustrated as part of image processing unit 190 in FIG. 1, may be encoded as instructions and stored in memory 704. The instructions stored in the one or more non-transitory computer-readable media may be executed by processing device 702.

In some examples, memory 704 may store data, e.g., data structures, binary data, bits, metadata, files, blobs, etc., as described with the FIGS. and herein. Memory 704 may store inputs, intermediate inputs, intermediate outputs, and outputs of method 600 of FIG. 6. Memory 704 may store raw images and processed images of imaging system 100 described and illustrated in FIG. 1.

In some examples, computing device 700 may include a communication device 712 (e.g., one or more communication devices). For example, communication device 712 may be configured for managing wired and/or wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some examples they might not. Communication device 712 may implement any of a number of wireless standards or protocols. Computing device 700 may include antenna 722 to facilitate wireless communications and/or to receive other wireless communications (such as radio frequency transmissions). Computing device 700 may include receiver circuits and/or transmitter circuits. In some examples, communication device 712 may manage wired communications, such as electrical, optical, or any other suitable communication protocols (e.g., the Ethernet). As noted above, communication device 712 may include multiple communication chips. For instance, a first communication device 712 may be dedicated to shorter-range wireless communications. In some examples, a first communication device 712 may be dedicated to wireless communications, and a second communication device 712 may be dedicated to wired communications.

Computing device 700 may include power source/power circuitry 714. The power source/power circuitry 714 may include one or more energy storage devices (e.g., batteries or capacitors) and/or circuitry for coupling components of the computing device 700 to an energy source separate from the computing device 700 (e.g., DC power, AC power, etc.).

Computing device 700 may include a display device 706 (or corresponding interface circuitry, as discussed above). The display device 706 may include any visual indicators, such as a heads-up display, a computer monitor, a projector, a touchscreen display, a liquid crystal display (LCD), a light-emitting diode display, or a flat panel display, for example.

Computing device 700 may include audio output device 708 (or corresponding interface circuitry, as discussed above). Audio output device 708 may include any device that generates an audible indicator, such as speakers, headsets, or earbuds, for example.

Computing device 700 may include audio input device 718 (or corresponding interface circuitry, as discussed above). Audio input device 718 may include any device that generates a signal representative of a sound, such as microphones, microphone arrays, or digital instruments (e.g., instruments having a musical instrument digital interface (MIDI) output).

Computing device 700 may include GPS device 716 (or corresponding interface circuitry, as discussed above). GPS device 716 may be in communication with a satellite-based system and may receive a location of the computing device 700, as known in the art.

Computing device 700 may include sensor 730 (or one or more sensors). Computing device 700 may include corresponding interface circuitry, as discussed above). Sensor 730 may sense physical phenomenon and translate the physical phenomenon into electrical signals that can be processed by, e.g., processing device 702. Examples of sensor 730 may include: image sensor, capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

Computing device 700 may include another output device 710 (or

corresponding interface circuitry, as discussed above). Examples of the other output device 710 may include an audio codec, a video codec, a printer, a wired or wireless transmitter for providing information to other devices, haptic output device, gas output device, vibrational output device, lighting output device, home automation controller, or an additional storage device.

Computing device 700 may include another input device 720 (or corresponding interface circuitry, as discussed above). Examples of the other input device 720 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 700 may have any desired form factor, such as a handheld or mobile computer system (e.g., a cell phone, a smart phone, a mobile internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or networked computing component, a printer, a scanner, a monitor, a set-top box, an entertainment control unit, a vehicle control unit, a digital camera, a digital video recorder, an Internet-of-Things device, or a wearable computer system. In some examples, the computing device 700 may be any other electronic device that processes data.

### SELECT EXAMPLES

Example 1 provides an image processing unit, including an image processing path to process raw-domain image data and output luma-domain image data; a coarse detail extraction circuit to generate one or more coarse detail layers based on one or more coarse scale images generated from the raw-domain image data; a fine details extraction circuit coupled to the image processing path to generate one or more fine detail layers based on one or more fine scale images generated from the luma-domain image data; a bridge conditioning circuit to output a conditioned coarse detail map based on the one or more coarse detail layers; a fusion circuit to output a detail map based on the conditioned coarse detail map and the one or more fine detail layers; and a detail restoration circuit to generate restored image data based on the detail map and image data derived from the luma-domain image data.

Example 2 provides the image processing unit of example 1, where the raw-domain image data includes Bayer image data.

Example 3 provides the image processing unit of example 1 or 2, where: the coarse detail extraction circuit is coupled to the image processing path before a demosaic circuit; and the fine details extraction circuit is coupled to the image processing path after the demosaic circuit.

Example 4 provides the image processing unit of any one of examples 1-3, where: the one or more coarse scale images include one or more progressively downscaled representations; and the one or more fine scale images include one or more further progressively downscaled representations, and a full-resolution luma image.

Example 5 provides the image processing unit of any one of examples 1-4, where one or more of the coarse detail extraction circuit or the fine details extraction circuit includes a guided filter circuit to generate an edge-preserving base image and to generate a corresponding detail layer based on a difference between an input image and the edge-preserving base image.

Example 6 provides the image processing unit of example 5, where the guided filter circuit includes a tone-mapping-aware variance normalization circuit to normalize one or more of a local variance and a variance threshold based on a tone mapping function.

Example 7 provides the image processing unit of any one of examples 1-6, where the bridge conditioning circuit is to apply one or more of scale conversion, spatial alignment, domain normalization, luminance correction, and parameterized weighting to the one or more coarse detail layers.

Example 8 provides the image processing unit of any one of examples 1-7, where the fusion circuit is to reduce same-phase overlap between adjacent detail layers and to preserve opposite-phase cancellation between the adjacent detail layers.

Example 9 provides the image processing unit of any one of examples 1-8, where the detail restoration circuit is to generate a detail factor based on the detail map and to generate the restored image data by applying the detail factor to tone-mapped image data derived from the luma-domain image data.

Example 10 provides the image processing unit of any one of examples 1-9, further including a segmentation-aware weighting circuit to: generate one or more power maps based on a segmentation map; resample power values of the one or more power maps to a target resolution corresponding to at least one of the one or more coarse detail layers or the one or more fine detail layers; and modulate the at least one of the one or more coarse detail layers or the one or more fine detail layers using the resampled power values.

Example 11 provides the image processing unit of any one of examples 1-10, further including a synchronization buffer in a raw-domain prior to a demosaic circuit of the image processing path to compensate for delay mismatch between the coarse detail extraction circuit and a downstream portion of the image processing path that supplies the luma-domain image data to the fine details extraction circuit.

Example 12 provides an image processing circuit, including a scale generation circuit to generate a plurality of scale images corresponding to different resolutions of input image data; a plurality of guided filter circuits corresponding to the plurality of scale images, where a guided filter circuit of the plurality of guided filter circuits is to generate an edge-preserving base image for a corresponding scale image and to generate a corresponding detail layer based on a difference between the corresponding scale image and the edge-preserving base image; and a fusion circuit to generate a multi-scale detail map based on the corresponding detail layers generated by the plurality of guided filter circuits.

Example 13 provides the image processing circuit of example 12, where: the plurality of scale images include one or more raw-domain scale images and one or more luma-domain scale images; and the fusion circuit includes a conditioning circuit to convert one or more detail layers generated from the one or more raw-domain scale images for fusion with one or more detail layers generated from the one or more luma-domain scale images.

Example 14 provides the image processing circuit of example 12 or 13, where the plurality of guided filter circuits include at least a guided filter circuit corresponding to coarse spatial-frequency detail and a further guided filter circuit corresponding to fine spatial-frequency detail.

Example 15 provides the image processing circuit of any one of examples 12-14, where the plurality of guided filter circuits include a guided filter circuit processing a lower-resolution scale image and a further guided filter circuit processing a higher-resolution scale image.

Example 16 provides the image processing circuit of example 15, where a detail layer generated by the guided filter circuit is upscaled before being fused with a further detail layer generated by the further guided filter circuit.

Example 17 provides the image processing circuit of any one of examples 12-16, where the fusion circuit is to fuse the corresponding detail layers in a coarse-to-fine order.

Example 18 provides the image processing circuit of any one of examples 12-17, where the fusion circuit is to reduce same-phase overlap between adjacent detail layers and to preserve opposite-phase cancellation between the adjacent detail layers.

Example 19 provides the image processing circuit of example 18, where the fusion circuit is to reduce an overlap contribution when adjacent detail layers have matching signs and to preserve cancellation between the adjacent detail layers when the adjacent detail layers have opposing signs.

Example 20 provides the image processing circuit of any one of examples 12-19, where at least two guided filter circuits of the plurality of guided filter circuits are configured with different guided filter parameters.

Example 21 provides the image processing circuit of example 20, where the different guided filter parameters include one or more of a support-window size, a coefficient-smoothing-window size, a threshold curve, a variance-normalization parameter, and a detail-power parameter.

Example 22 provides the image processing circuit of any one of examples 12-21, where one or more guided filter circuits of the plurality of guided filter circuits includes a tone-mapping-aware variance normalization circuit to normalize one or more of a local variance and a variance threshold based on a tone mapping function.

Example 23 provides the image processing circuit of any one of examples 12-22, where one or more guided filter circuits of the plurality of guided filter circuits includes a local statistics circuit to compute a local variance over a support window and a coefficient smoothing circuit to smooth guided filter coefficients over a further support window different from the support window.

Example 24 provides the image processing circuit of any one of examples 12-23, where the fusion circuit further includes a weighting circuit to apply one or more per-scale weights to one or more of the corresponding detail layers before generation of the multi-scale detail map.

Example 25 provides the image processing circuit of example 24, where the one or more per-scale weights are based on a segmentation map.

Example 26 provides the image processing circuit of any one of examples 12-25, where the multi-scale detail map is used to generate restored image data.

Example 27 provides a method of image processing, including generating a plurality of scale images corresponding to different resolutions of input image data; generating, by a plurality of guided-filter circuits corresponding to the plurality of scale images, a plurality of edge-preserving base images for respective ones of the plurality of scale images; generating a plurality of detail layers based on differences between respective ones of the plurality of scale images and corresponding ones of the plurality of edge-preserving base images; and fusing the plurality of detail layers to generate a multi-scale detail map.

Example 28 provides the method of example 27, where the plurality of scale images include one or more raw-domain scale images and one or more luma-domain scale images.

Example 29 provides the method of example 27 or 28, where the plurality of scale images include at least three scale images having different resolutions, the at least three scale images including at least one raw-domain scale image and at least one luma-domain scale image.

Example 30 provides the method of example 28 or 29, where generating the plurality of detail layers includes generating one or more coarse detail layers from the one or more raw-domain scale images and generating one or more fine detail layers from the one or more luma-domain scale images.

Example 31 provides the method of example 30, further including conditioning the one or more coarse detail layers before fusing the one or more coarse detail layers with the one or more fine detail layers.

Example 32 provides the method of example 31, where conditioning the one or more coarse detail layers includes applying one or more of scale conversion, spatial alignment, domain normalization, luminance correction, and parameterized weighting.

Example 33 provides the method of any one of examples 27-32, where fusing the plurality of detail layers includes upscaling a lower-resolution detail layer and fusing the upscaled lower-resolution detail layer with a higher-resolution detail layer.

Example 34 provides the method of any one of examples 27-33, where the plurality of detail layers are fused in a coarse-to-fine order.

Example 35 provides the method of any one of examples 27-34, where fusing the plurality of detail layers includes reducing reduce same-phase overlap between adjacent detail layers and preserving opposite-phase cancellation between the adjacent detail layers.

Example 36 provides the method of example 27-35, where fusing the plurality of detail layers includes performing sign-aware fusion by suppressing an overlap contribution between adjacent detail layers having matching signs and reducing or omitting an overlap suppression between adjacent detail layers having opposing signs.

Example 37 provides the method of any one of examples 27-36, where generating the plurality of edge-preserving base images includes applying different guided-filter parameters for at least two different resolutions of the plurality of scale images.

Example 38 provides the method of example 37, where the different guided-filter parameters include one or more of a support-window size, a coefficient-smoothing-window size, a threshold curve, a variance-normalization parameter, and a detail-power parameter.

Example 39 provides the method of any one of examples 27-38, further including, for at least one of the plurality of scale images: computing a local variance; normalizing one or more of the local variance and a variance threshold based on a tone mapping function; and generating a corresponding one of the plurality of edge-preserving base images using the normalized local variance or the normalized variance threshold.

Example 40 provides the method of any one of examples 27-39, further including generating restored image data based on the multi-scale detail map and tone-mapped image data.

### VARIATIONS AND REMARKS

Although the operations of the example method shown in and described with reference to the FIGS. are illustrated as occurring once each and in a particular order, it will be recognized that the operations may be performed in any suitable order and repeated as desired. Additionally, one or more operations may be performed in parallel. Furthermore, the operations illustrated in the FIGS. may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well-known features are omitted or simplified in order not to obscure the illustrative implementations.

Further, references are made to the accompanying drawings that form a part hereof, and in which are shown, by way of illustration, examples that may be practiced. It is to be understood that other examples may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter.

However, the order of description should not be construed as to imply that these operations are necessarily order-dependent. In particular, these operations may not be performed in the order of presentation. Operations described may be performed in a different order from the described example. Various additional operations may be performed or described operations may be omitted in additional examples.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). For the purposes of the present disclosure, the phrase “one or more of A, B, and C”, the phrase “at least one of A, B, and C”, or the phrase “at least one or more of A, B, and C” means (A), (B), (C), (A and B), (A and C), (B and C), or (A, B, and C). The term “between,” when used with reference to measurement ranges, is inclusive of the ends of the measurement ranges.

The description uses the phrases “in an example” or “in examples,” which may each refer to one or more of the same or different examples. The terms “comprising,” “including,” “having,” and the like, as used with respect to examples of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. An image processing unit, comprising:
an image processing path to process raw-domain image data and output luma-domain image data;
a coarse detail extraction circuit to generate one or more coarse detail layers based on one or more coarse scale images generated from the raw-domain image data;
a fine details extraction circuit coupled to the image processing path to generate one or more fine detail layers based on one or more fine scale images generated from the luma-domain image data;
a bridge conditioning circuit to output a conditioned coarse detail map based on the one or more coarse detail layers;
a fusion circuit to output a detail map based on the conditioned coarse detail map and the one or more fine detail layers; and
a detail restoration circuit to generate restored image data based on the detail map and image data derived from the luma-domain image data.

2. The image processing unit of claim 1, wherein the raw-domain image data comprises Bayer image data.

3. The image processing unit of claim 1, wherein:
the coarse detail extraction circuit is coupled to the image processing path before a demosaic circuit; and
the fine details extraction circuit is coupled to the image processing path after the demosaic circuit.

4. The image processing unit of claim 1, wherein:
the one or more coarse scale images comprise one or more progressively downscaled representations; and
the one or more fine scale images comprise one or more further progressively downscaled representations, and a full-resolution luma image.

5. The image processing unit of claim 1, wherein one or more of the coarse detail extraction circuit or the fine details extraction circuit comprises a guided filter circuit to generate an edge-preserving base image and to generate a corresponding detail layer based on a difference between an input image and the edge-preserving base image.

6. The image processing unit of claim 5, wherein the guided filter circuit comprises a tone-mapping-aware variance normalization circuit to normalize one or more of a local variance and a variance threshold based on a tone mapping function.

7. The image processing unit of claim 1, wherein the bridge conditioning circuit is to apply one or more of scale conversion, spatial alignment, domain normalization, luminance correction, and parameterized weighting to the one or more coarse detail layers.

8. The image processing unit of claim 1, wherein the fusion circuit is to reduce same-phase overlap between adjacent detail layers and to preserve opposite-phase cancellation between the adjacent detail layers.

9. The image processing unit of claim 1, wherein the detail restoration circuit is to generate a detail factor based on the detail map and to generate the restored image data by applying the detail factor to tone-mapped image data derived from the luma-domain image data.

10. The image processing unit of claim 1, further comprising a segmentation-aware weighting circuit to:
generate one or more power maps based on a segmentation map;
resample power values of the one or more power maps to a target resolution corresponding to at least one of the one or more coarse detail layers or the one or more fine detail layers; and
modulate the at least one of the one or more coarse detail layers or the one or more fine detail layers using the resampled power values.

11. The image processing unit of claim 1, further comprising a synchronization buffer in a raw-domain prior to a demosaic circuit of the image processing path to compensate for delay mismatch between the coarse detail extraction circuit and a downstream portion of the image processing path that supplies the luma-domain image data to the fine details extraction circuit.

12. An image processing circuit, comprising:
a scale generation circuit to generate a plurality of scale images corresponding to different resolutions of input image data;
a plurality of guided filter circuits corresponding to the plurality of scale images, wherein a guided filter circuit of the plurality of guided filter circuits is to generate an edge-preserving base image for a corresponding scale image and to generate a corresponding detail layer based on a difference between the corresponding scale image and the edge-preserving base image; and
a fusion circuit to generate a multi-scale detail map based on the corresponding detail layers generated by the plurality of guided filter circuits.

13. The image processing circuit of claim 12, wherein:
the plurality of scale images comprise one or more raw-domain scale images and one or more luma-domain scale images; and
the fusion circuit comprises a conditioning circuit to convert one or more detail layers generated from the one or more raw-domain scale images for fusion with one or more detail layers generated from the one or more luma-domain scale images.

14. The image processing circuit of claim 12, wherein the plurality of guided filter circuits comprise at least a guided filter circuit corresponding to coarse spatial-frequency detail and a further guided filter circuit corresponding to fine spatial-frequency detail.

15. The image processing circuit of claim 12, wherein the plurality of guided filter circuits comprise a guided filter circuit processing a lower-resolution scale image and a further guided filter circuit processing a higher-resolution scale image.

16. The image processing circuit of claim 15, wherein a detail layer generated by the guided filter circuit is upscaled before being fused with a further detail layer generated by the further guided filter circuit.

17. The image processing circuit of claim 12, wherein the fusion circuit is to fuse the corresponding detail layers in a coarse-to-fine order.

18. The image processing circuit of claim 12, wherein the fusion circuit is to reduce same-phase overlap between adjacent detail layers and to preserve opposite-phase cancellation between the adjacent detail layers.

19. A method of image processing, comprising:
generating a plurality of scale images corresponding to different resolutions of input image data;
generating, by a plurality of guided-filter circuits corresponding to the plurality of scale images, a plurality of edge-preserving base images for respective ones of the plurality of scale images;
generating a plurality of detail layers based on differences between respective ones of the plurality of scale images and corresponding ones of the plurality of edge-preserving base images; and
fusing the plurality of detail layers to generate a multi-scale detail map.

20. The method of claim 19, wherein the plurality of scale images comprise one or more raw-domain scale images and one or more luma-domain scale images.
